(19) United States
(12) Patent Application Publication
(10) Pub. No.: US 2017/0262411 A1
(43) Pub. Date: Sep. 14, 2017

(54) CALCULATOR AND MATRIX FACTORIZATION METHOD

(71) Applicant: FUJITSU LIMITED, Kawasaki-shi (JP)

(72) Inventor: MAKOTO NAKANISHI, TAGATA (JP)

(73) Assignee: FUJITSU LIMITED, Kawasaki-shi (JP)

(21) Appl. No.: 15/451,504

(22) Filed: Mar. 7, 2017

(30) Foreign Application Priority Data
Mar. 11, 2016 (JP) 2016-047883

(51) Int. Cl. G06F 17/16; G06F 7/535

(52) U.S. Cl. CPC G06F 17/16; G06F 7/535

(57) ABSTRACT

For each process unit, a calculator allocates, in a storing unit, a first storage area with a storage capacity corresponding to the total data volume obtained by adding the data volume of rows and columns included in the process unit to the data volume of a predetermined count of rows and columns. Using the first storage area, the calculator performs first factorization on the rows and columns of each target process unit and rows and columns transferred from process units having already undergone factorization processing. The calculator allocates, in the storing unit, a second storage area when there are, among rows and columns determined to be transferred as a result of the first factorization, those that do not fit in and are left out of the first storage area. The calculator performs second factorization on the left-out rows and columns using the second storage area.

### CROSS-REFERENCE TO RELATED APPLICATION

This application is based upon and claims the benefit of priority of the prior Japanese Patent Application No. 2016-047883, filed on Mar. 11, 2016, the entire contents of which are incorporated herein by reference.

### FIELD

The embodiments discussed herein are related to a calculator and a matrix factorization method.

### BACKGROUND

In running simulations (e.g. fluid analyses, circuit analyses, and biomedical analyses of hearts or the like) or solving mathematical programming problems based on mathematical models described by, for example, partial differential equations, the solution of a set of simultaneous linear equations represented by a sparse matrix is sometimes calculated. The term “sparse matrix” refers to a matrix where the vast majority of the entries are zero. A set of simultaneous linear equations with a sparse matrix may be solved by calculating LU or LDL^{T} factorization of the sparse matrix. LU factorization decomposes (or factors) a square matrix into the product of a lower triangular matrix (L) and an upper triangular matrix (U). LDL^{T} factorization decomposes a square matrix into the product of a lower triangular matrix (L), a diagonal matrix (D), and the transpose of the lower triangular matrix (L^{T}).

In order to solve a set of simultaneous linear equations with a sparse matrix using LU or LDL^{T} factorization, a supernodal approach is used, for example. In the supernodal approach, adjacent columns with nearly identical nonzero patterns are grouped together to form each supernode, and storage area appropriate for storing factorization results is allocated to each supernode and numerical factorization is performed using the storage area.

In matrix factorization such as LU and LDL^{T} factorization, an operation takes place to subtract a constant multiple of each element in a row including the diagonal element called “pivot” (the row containing the pivot is called the “pivot row”) from an element in the corresponding position in each row below the pivot row, to thereby make each element below the pivot into a zero. This operation is premised on the value of the pivot being sufficiently large, and the factorization is no longer possible if the diagonal element being the pivot takes a small or zero value. In order to avoid this problem, a technique known as delayed pivoting is employed. In this technique, if a diagonal element is found to be unsuitable to be a pivot, it is moved to a later position in the pivot sequence (i.e., in the directions of increasing row and column numbers) by row and column transfer. After the unsuitable diagonal element is moved to the later position, the value of the diagonal element is updated during factorization of preceding rows and thereby expected to take a sufficiently large value to be a pivot.

As for simulation using sparse matrix techniques, there has been proposed a matrix equation calculation method enabling high-speed calculation of a large sparse matrix equation, which appears as an equation to be solved eventually in numerical simulation such as an electromagnetic field analysis. In addition, as an example of a method for finding the solution to simultaneous linear equations that includes a sparse matrix as a coefficient matrix, there has been proposed a simultaneous linear equation solution employing a high-speed symbolic factorization technique. Further, a technology has been proposed which determines quickly and automatically an appropriate value of a relaxation parameter according to a problem in a solution to simultaneous linear equations using a Successive Over-Relaxation (SOR) or Symmetric SOR (SSOR) method.

See, for example, Japanese Laid-open Patent Publication Nos. 2010-122850, 2009-25962, and 2015-49724.

In the case where delayed pivoting is applied to a direct method that uses the supernodal approach to solve simultaneous linear equations represented by a sparse matrix, row and column permutations result in dynamic changes in matrix elements of each supernode. In addition, row and column backward transfer in the matrix involves additional storage for the elements of rows and columns transferred, which in turn leads to dynamic changes in memory usage. However, it is burdensome to dynamically allocate memory storage area each time the memory usage increases. That is, application of both the supernodal approach and the delayed pivoting technique incurs excessively high memory management load.

### SUMMARY

According to an aspect, there is provided a calculator including a memory configured to store, as results of factorization of a matrix, a plurality of matrices including a lower triangular matrix and an upper triangular matrix, the matrix having nonzero elements arranged symmetrically along a diagonal; and a processor configured to perform a procedure including: dividing, based on an arrangement of the nonzero elements, the matrix into a plurality of process units for factorization processing, each of which is a set of rows and columns sharing successive diagonal elements, and allocating, in the memory, a first storage area with a storage capacity with respect to each of the plurality of process units, the storage capacity of the first storage area corresponding to a total data volume obtained by adding a data volume of the set of rows and columns of the process unit to a data volume of a predetermined count of rows and columns, selecting each of the plurality of process units as a target process unit in a predetermined order, and performing, with use of the first storage area, a first factorization process on the set of rows and columns of the target process unit and rows and columns transferred to the target process unit, the rows and columns being transferred from process units having already undergone the factorization processing because values of diagonal elements shared by the rows and columns are individually less than or equal to a predetermined value, allocating, in the memory, a second storage area with a storage capacity when there are, among rows and columns determined to be transferred as a result of the first factorization process because values of diagonal elements shared by the rows and columns are individually less than or equal to a predetermined value, rows and columns that do not fit in and are therefore left out of the first storage area, the storage capacity of the second storage area corresponding to a data volume of the rows and columns left out of the first storage area, and performing a second factorization process on the rows and columns left out of the first storage area with use of the second storage area.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a configuration example of a calculator according to a first embodiment;

FIG. 2 illustrates an example of a hardware configuration of a computer according to a second embodiment

FIG. 3 illustrates delayed pivoting;

FIG. 4 illustrates a supernode;

FIG. 5 illustrates an example of LL^{T} factorization;

FIG. 6 illustrates an example of generated elimination tree and row subtrees;

FIG. 7 is a block diagram illustrating functions of the computer;

FIG. 8 is a flowchart illustrating a procedure of LU factorization of a structurally symmetric sparse real matrix;

FIG. 9 illustrates an example of panel configurations used in the LU factorization of the structurally symmetric sparse real matrix;

FIG. 10 illustrates an example of area management information;

FIG. 11 illustrates a data structure example of a matrix factorization workspace;

FIG. 12 illustrates transfer of rows and columns between supernodes;

FIG. 13 illustrates an example of transferring a delayed pivot;

FIG. 14 illustrates an example of delayed pivots to be transferred;

FIG. 15 illustrates a supernode to which the delayed pivots are transferred;

FIG. 16 illustrates an example of transferring a delayed pivot produced by factorization of a primary supernode;

FIG. 17 is a flowchart illustrating a procedure of LU factorization;

FIG. 18 is a flowchart illustrating processing of subroutine rsupdate;

FIG. 19 is a flowchart illustrating processing of subroutine dpcount;

FIG. 20 is a flowchart illustrating processing of subroutine mvtonporder;

FIG. 21 is a flowchart illustrating processing of subroutine cpupdate;

FIG. 22 is a flowchart illustrating processing of subroutine rpupdate;

FIG. 23 is a flowchart illustrating processing of subroutine createmv;

FIG. 24 is a flowchart illustrating processing of subroutine cpupdatenew;

FIG. 25 is a flowchart illustrating processing of subroutine rpupdatenew;

FIG. 26 is a flowchart illustrating a procedure of LDL^{T} factorization of a sparse symmetric indefinite matrix;

FIG. 27 illustrates an example of a panel configuration used in the LDL^{T} factorization of the sparse symmetric indefinite matrix;

FIG. 28 illustrates an example of transferring a delayed pivot in the LDL^{T} factorization of the symmetric indefinite matrix;

FIG. 29 is a flowchart illustrating a procedure of the LDL^{T} factorization;

FIG. 30 is a flowchart illustrating processing of subroutine symrsupdate;

FIG. 31 is a flowchart illustrating processing of subroutine symdpcount;

FIG. 32 is a flowchart illustrating processing of subroutine symmvtonporder;

FIG. 33 is a flowchart illustrating processing of subroutine symcpupdate;

FIG. 34 is a flowchart illustrating processing of subroutine symcreatemv; and

FIG. 35 is a flowchart illustrating processing of subroutine symcpupdatenew.

### DESCRIPTION OF EMBODIMENTS

Several embodiments will be described below with reference to the accompanying drawings, wherein like reference numerals refer to like elements throughout. Note that two or more of the embodiments below may be combined for implementation in such a way that no contradiction arises.

### (a) First Embodiment

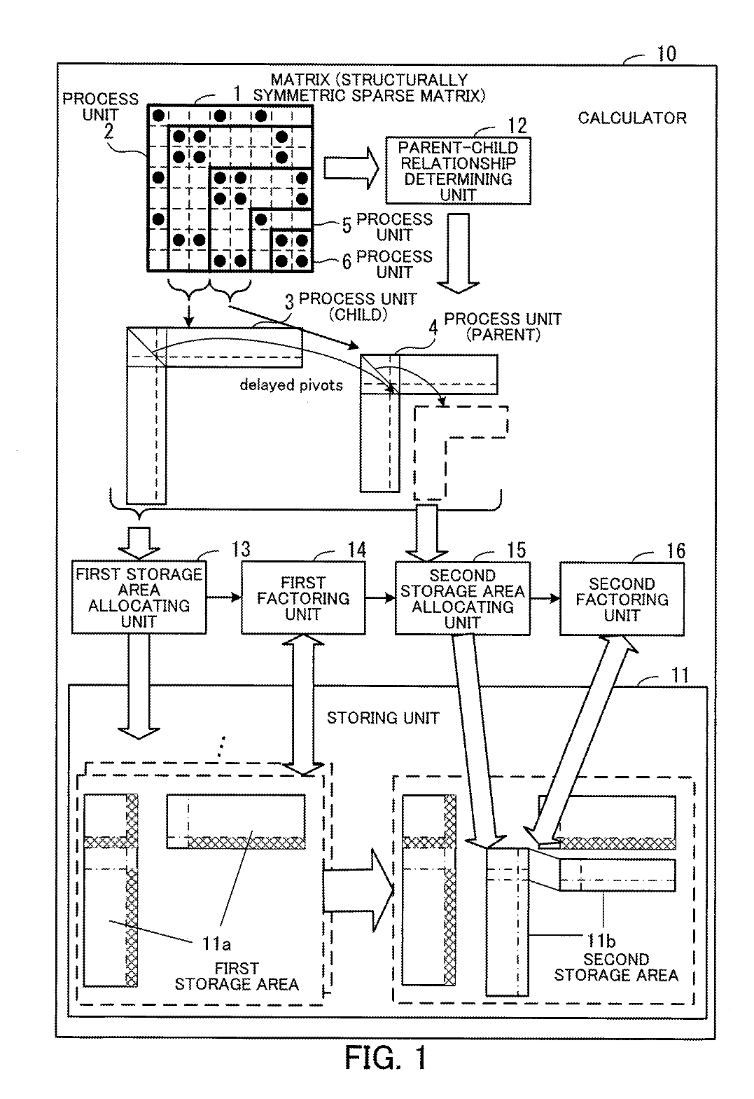

FIG. 1 illustrates a configuration example of a calculator according to a first embodiment. A calculator of the first embodiment is configured to factor a matrix 1 with nonzero elements arranged symmetrically along the diagonal into a plurality of matrices including a lower triangular matrix and an upper triangular matrix. For example, the matrix 1 is a sparse matrix where the vast majority of the entries are zero. The calculator 10 calculates LU or LDL^{T} factorization of the matrix 1. In order to factor the matrix 1, the calculator 10 includes storing unit 11; parent-child relationship determining unit 12; first storage area allocating unit 13; first factoring unit 14; second storage area allocating unit 15; and second factoring unit 16.

The storing unit 11 stores therein results of the factorization of the matrix 1. The matrix 1 is divided into a plurality of process units 2 to 6. Each of the process units 2 to 6 is a set of columns with identical nonzero-element arrangement and rows sharing diagonal elements with the columns. Each of the process units 2 to 6 undergoes a factorization process.

The parent-child relationship determining unit 12 determines parent-child relationships among the process units 2 to 6 according to predetermined rules. For example, in the case where the values of elements in the process unit 4 are updated as a result of the factorization process of the process unit 3, the process unit 3 is the child and the process unit 4 is the parent in the parent-child relationship of these two process units 3 and 4.

The first storage area allocating unit 13 divides the matrix 1 into a plurality of process units 2 to 6 based on the arrangement of the nonzero elements. In this regard, a set of rows and columns sharing successive diagonal elements is referred to as a process unit for factorization. For example, the first storage area allocating unit 13 treats a set of rows and columns with an identical or nearly identical nonzero-element arrangement as a factorization process unit. Such factorization process units are referred to as supernodes in the context of the supernodal approach. Then, with respect to each of the process units, the first storage area allocating unit 13 allocates, in the storing unit 11, a first storage area 11a with a storage capacity corresponding to the total data volume obtained by adding the data volume of rows and columns included in the process unit to the data volume of a predetermined count of rows and columns (the hatched area in FIG. 1).

The first factoring unit 14 selects each of the process units 2 to 6 as a target process unit in a predetermined order. Then, using the first storage area 11a, the first factoring unit 14 performs the factorization process on the rows and columns of the target process unit as well as rows and columns transferred from a process unit having already undergone the factorization process because the values of their diagonal elements are less than or equal to a predetermined value. For example, the first factoring unit identifies, amongst process units having already undergone their factorization processes, a child process unit of the target process unit, and moves rows and columns that were excluded from the factorization process of the child process unit due to the value of each of their diagonal elements being less than or equal to a predetermined value to positions following the rows and columns, respectively, of the target process unit. Such a row and column transfer technique is known as delayed pivoting. The delayed pivoting allowing not only row permutations but also column permutations avoids the nonzero-element arrangement of the matrix 1 from losing its symmetric property and, therefore, prevents increased memory usage.

Note that only rows and columns enough to fit in the first storage area 11a are transferred to the first storage area 11a in delayed pivoting. If there are so many rows and columns to be moved to the target process unit in delayed pivoting that some rows and columns would be left out of the first storage area 11a of the target process unit, the left-out rows and columns are transferred after allocation of a second storage area 11b. Therefore, the first factoring unit 14 performs the factorization process only on the rows and columns allowed to be stored in the first storage area 11a.

The second storage area allocating unit 15 determines whether all the following fits in the first storage area 11a: the rows and columns transferred from the preceding process unit having already undergone the factorization process; and rows and columns determined to be moved as a result of the factorization process of the target process unit due to the value of each of their diagonal elements being less than or equal to the predetermined value. Then, if there are rows and columns that do not fit in the first storage area 11a, the second storage area allocating unit 15 allocates, in the storing unit 11, the second storage area 11b with a storage capacity corresponding to the data volume of the rows and columns left out of the first storage area 11a. Using the second storage area 11b, the second factoring unit 16 performs the factorization process on the rows and columns left out of the first storage area 11a.

According to the above-described calculator 10, in factoring the matrix 1, the first storage area 11a with extra spaces is allocated for each of the process units 2 to 6. Then, in the factorization process of each of the process units 2 to 6, the second storage area 11b is allocated only if transfer of rows and columns whose data volume exceeds the capacity of the first storage area 11a has taken place due to delayed pivoting. Therefore, in the case where all rows and columns transferred in association with delayed pivoting fit in the extra spaces of the first storage area 11a, there is no need to allocate the second storage area 11b, thus achieving efficient memory management.

In addition, as for the allocation of the second storage area 11b, the second storage area 11b has a collective storage capacity that accommodates, amongst a number of rows and columns to be transferred due to delayed pivoting, those not fitting into and left out of the first storage area 11a. That is, the additional storage area allocating process needs to be carried out only once for one process unit. Therefore, compared to the case of allocating storage area each time row and column transfer due to delayed pivoting takes place, more efficient memory management is achieved.

In the case where a row-and-column transfer target is the i^{th} row and column (i is an integer greater than or equal to 1; the i^{th} row and column are hereinafter denoted by “row and column i”), the first factoring unit 14 and the second factoring unit 16 transfer, amongst all elements in column i, those with row numbers equal to and greater than i to a position following the columns belonging to the target process unit. In addition, the first factoring unit 14 and the second factoring unit 16 transfer, amongst all elements in row i, those with column numbers greater than i to a position following the rows belonging to the target process unit. That is, amongst the elements of row and column i of the matrix 1, only those with both row and column numbers are equal to and greater than i are transferred. This reduces storage capacity requirements at the transfer destination.

Note that the parent-child relationship determining unit 12, the first storage area allocating unit 13, the first factoring unit 14, the second storage area allocating unit 15; and the second factoring unit 16 may be implemented, for example, by a processor of the calculator 10. The storing unit 11 may be implemented, for example, by memory of the calculator 10 or a storage device. In FIG. 1, lines connecting the individual components represent a part of communication paths, and communication paths other than those illustrated in FIG. 1 are also configurable.

### (b) Second Embodiment

A second embodiment is described next. The second embodiment is directed to a computer for efficiently calculating the solution of a set of simultaneous linear equations represented by a sparse matrix in running simulations or solving mathematical programming problems based on mathematical models described by, for example, partial differential equations.

<Hardware Configuration>

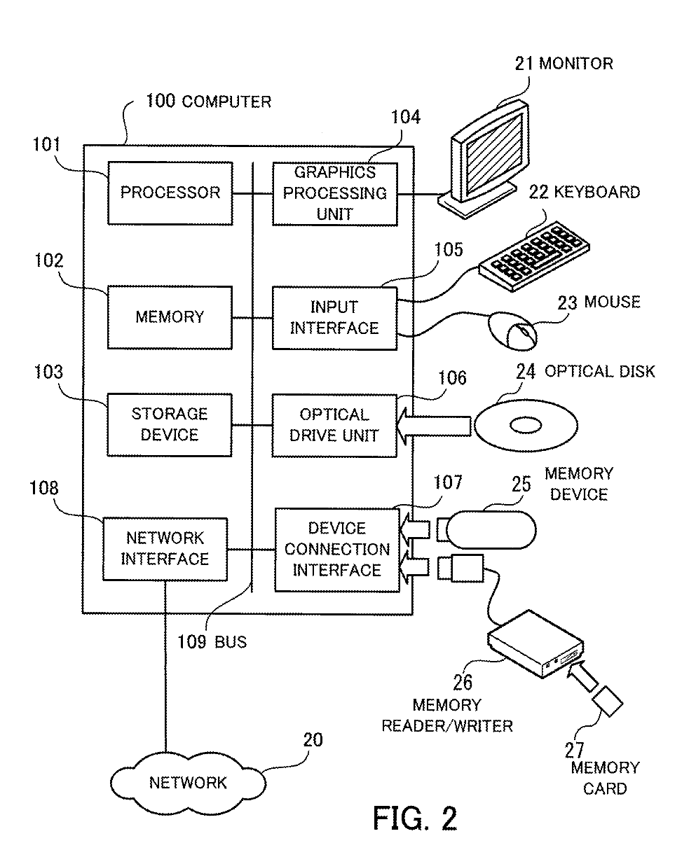

A hardware configuration of the computer according the second embodiment is described first. FIG. 2 illustrates an example of the hardware configuration of the computer according to the second embodiment. Overall control of a computer 100 is exercised by a processor 101. To the processor 101, memory 102 and a plurality of peripherals are connected via a bus 109. The processor 101 may be a multi-processor. The processor 101 is, for example, a central process unit (CPU), a micro process unit (MPU), or a digital signal processor (DSP). At least part of the functions implemented by executing a program by the processor 101 may be implemented by an electronic circuit, such as an application specific integrated circuit (ASIC) and a programmable logic device (PLD).

The memory 102 is used as a main memory device of the computer 100. The memory 102 temporarily stores at least part of an operating system (OS) program and application programs to be executed by the processor 101. The memory 102 also stores therein various types of data to be used by the processor 101 for its processing. As the memory 102, a volatile semiconductor storage device such as random access memory (RAM) may be used.

The peripherals connected to the bus 109 include a storage device 103, a graphics process unit 104, an input interface 105, an optical drive unit 106, a device connection interface 107, and a network interface 108. The storage device 103 electrically or magnetically writes and reads data to and from a built-in memory medium, and is used as a secondary storage device of the computer 100. The storage device 103 stores therein the OS program, application programs, and various types of data. A hard disk drive (HDD) or solid state drive (SSD), for example, may be used as the storage device 103.

To the graphics process unit 104, a monitor 21 is connected. According to an instruction from the processor 101, the graphics process unit 104 displays an image on a screen of the monitor 21. A cathode ray tube (CRT) display or a liquid crystal display, for example, may be used as the monitor 21. To the input interface 105, a keyboard 22 and a mouse 23 are connected. The input interface 105 transmits signals sent from the keyboard 22 and the mouse 23 to the processor 101. Note that the mouse 23 is just an example of pointing devices, and a different pointing device such as a touch panel, a tablet, a touch-pad, and a track ball, may be used instead.

The optical drive unit 106 reads data recorded on an optical disk 24 using, for example, laser light. The optical disk 24 is a portable storage medium on which data is recorded in such a manner as to be read by reflection of light. Examples of the optical disk 24 include a digital versatile disc (DVD), a DVD-RAM, a compact disk read only memory (CD-ROM), a CD recordable (CD-R), and a CD-rewritable (CD-RW).

The device connection interface 107 is a communication interface for connecting peripherals to the computer 100. To the device connection interface 107, for example, a memory device 25 and a memory reader/writer 26 may be connected. The memory device 25 is a storage medium having a function for communicating with the device connection interface 107. The memory reader/writer 26 is a device for writing and reading data to and from a memory card 27 which is a card-type storage medium. The network interface 108 is connected to a network 20. Via the network 20, the network interface 108 transmits and receives data to and from other computers and communication devices.

The hardware configuration described above achieves the processing functions of the second embodiment. Note that the calculator of the first embodiment may also be built with the same hardware configuration as the computer 100 of FIG. 2. The computer 100 achieves its processing functions according to the second embodiment, for example, by executing a program stored in a computer-readable storage medium. The program describing processing content to be implemented by the computer 100 may be stored in various types of storage media. For example, the program to be executed by the computer 100 may be stored in the storage device 103. The processor 101 loads at least part of the program stored in the storage device 103 into the memory 102 and then runs the program. In addition, the program to be executed by the computer 100 may be stored in a portable storage medium, such as the optical disk 24, the memory device 25, and the memory card 27. The program stored in the portable storage medium becomes executable after being installed on the storage device 103, for example, under the control of the processor 101. Alternatively, the processor 101 may run the program by directly reading it from the portable storage medium.

<Overview of Matrix Factorization Process>

The computer 100 of FIG. 2 performs LU or LDL^{T} factorization of a set of simultaneous linear equations with a sparse matrix, using a supernodal approach in conjunction with delayed pivoting. An overview of a matrix factorization process performed by the computer 100 is described first. In the case of factoring a matrix using the supernodal approach, the computer 100 performs symbolic factorization prior to numerical factorization. Based on the results of the symbolic factorization, the computer 100 obtains information on, for example, fill-in (introduction of nonzero elements) and each dependency between nodes individually corresponding to a column number (and a row number). The term “node” here refers to a pair of a row and a column sharing the same diagonal element. In addition, the term “dependency between nodes” refers to a relationship in which the factorization process of one node causes updates of the values of elements in the other node. In this case, the node having undergone the factorization process is called a child node, and the node with elements whose values are updated as a result of the factorization process of the child node is called a parent node. Based on the information obtained from the results of the symbolic factorization, the computer 100 groups together consecutive nodes with nearly identical nonzero patterns to form each supernode, and constructs a supernodal elimination tree and supernodal row subtrees that represent dependencies among supernodes. Each supernode includes one or more nodes.

The computer 100 calculates the size of a panel or panels for storing results obtained by factoring each supernode. Then, the computer 100 uses a memory area assigned to the supernode according to the calculated panel size to thereby perform numerical factorization. In order to enhance the stability of the factorization to thereby improve its accuracy, a pivot is selected from a diagonal block (a region including one or more diagonal elements) corresponding to the supernode. However, if there is no acceptable pivot, the computer 100 implements delayed pivoting. In implementing delayed pivoting in the supernodal approach, the computer 100 establishes, as a panel/panels for storing the results of the factorization of the supernode, a storage area with extra space added in view of row and column transfer. The count of columns/rows representing the size of the extra space to be added is designated to the computer 100 prior to the symbolic factorization. The computer 100 calculates the size of the panel/panels each with the added space based on the information obtained from the symbolic factorization, and assigns the panel/panels to the supernode before the numerical factorization. The supernode to which the panel/panels are assigned at this point in time is here referred to as the “primary supernode”.

In the case where the added space is not enough and the storage capacity has run out, the computer 100 creates a secondary supernode in the transfer-destination supernode, and assigns a storage panel/panels to the secondary supernode and transfers pivots thereto (i.e., the pivots are delayed). The panel/panels assigned by the computer 100 to the secondary supernode have a size enough to accommodate delayed pivots left out of the added space as well as delayed pivots newly produced by the LU or LDL^{T} factorization of the transfer-destination supernode.

The computer 100 assigns a memory pool with designated size used to assign the panel/panels for the secondary supernode at the same time as assigning the panel/panels for the primary supernode, and dynamically allocates and assigns the panel/panels to the secondary supernode from the memory pool. Thus, in order to incorporate delayed pivoting into the supernodal approach, a space is added to each panel of the supernode, and when the space for delayed pivoting runs out, a secondary supernode is created for delayed pivoting.

<Delayed Pivoting>

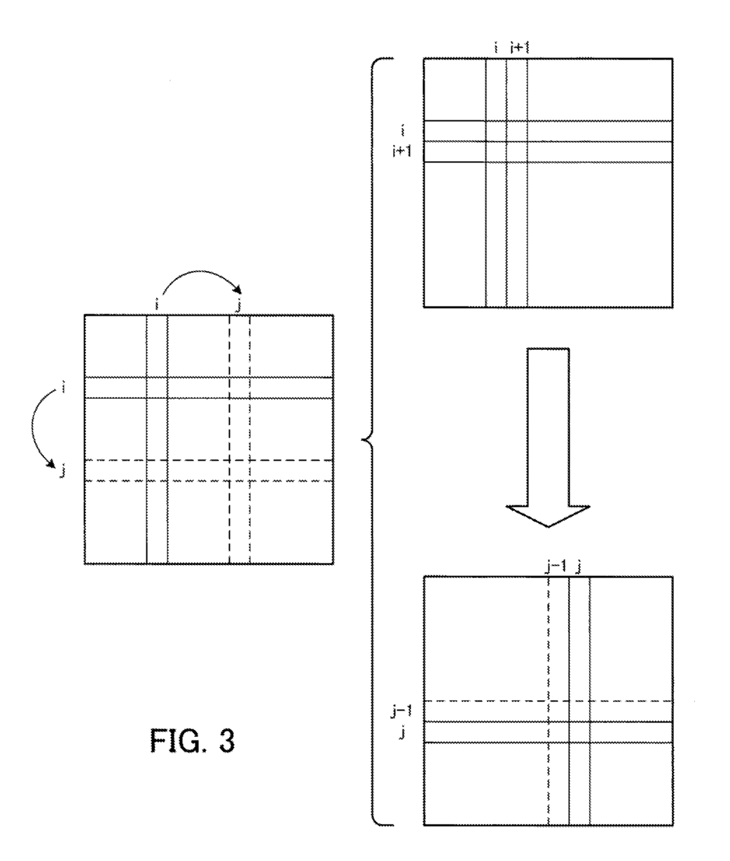

Delayed pivoting is described next in detail. In performing LU factorization of a matrix using a direct method to solve simultaneous linear equations, it is sometimes the case that the factorization is no longer possible if a diagonal element being the pivot takes a small or zero value. In order to avoid this problem, a technique known as delayed pivoting is employed. FIG. 3 illustrates delayed pivoting. In delayed pivoting, if a diagonal element is found to be unsuitable to be a pivot, it is moved to a later position in the pivot sequence by symmetric permutations. The example of FIG. 3 depicts the case of moving the diagonal element in row and column i (i is an integer greater than or equal to 1) to a later position, row and column j (j is an integer greater than or equal to 1). In this case, the computer 100, first, symmetrically permutes row i with row i+1. This results in permutations of the two rows and their corresponding columns.

For example, assume here that a matrix P is a permutation matrix, and an element in row a and column b (a and b are integers greater than or equal to 1) of the matrix P is denoted by p_{a,b}. Assume also that the matrix P is an orthogonal matrix where p_{i,i}=p_{i+1,i+1}=0, p_{i+1,i}=p_{i,i+1}=1, and p_{j,j}=1 (j is different from i and i+1) and the remaining elements are all 0. When a factorization-target matrix A is multiplied with the matrix P from the left, row i and row i+1 are permuted with each other. When the matrix A is multiplied with the matrix P from the right, column i and column i+1 are permuted with each other. The permutation operation is expressed as:

B=PAP^{T}

where B is the matrix after the permutations.

This operation corresponds to symmetrically permuting row and column i with row and column i+1. When similar permutation operations are applied successively to (i, i+1), (i+1, i+2), . . . , and (j−1, j), row and column i are permuted to row and column j while permuting i+1, . . . , and j to i, . . . , and j−1, respectively. This corresponds to sequentially multiplying the matrix A with Pᵢ, pᵢ₊₁, . . . , and Pⱼ₋₁ from both sides. Note however that Pᵢ is an orthogonal matrix used to permute row i with row i+1 when being multiplied with the matrix A from the left.

Continuing factorization with such permutations implements update of the element (j, j) during the subsequent factorization of each row and column, and it is expected that the absolute value of this element would become large enough to meet the requirement to be a pivot. If the element fails to take a sufficiently large value in the factorizations after the permutations, the element is again moved to a later position, and this operation is repeated until the element becomes sufficient to be a pivot. Thus, delayed pivoting is a process which transfers a row and column including a pivot candidate to a later position by symmetric permutations.

In the case of permuting row and column i with row and column i+1, an element a_{i,i} in row and column i is permuted with an element a_{i+1,i+1} in row and column i+1. Then, the element is updated as follows by LU factorization of row and column i and an outer product update: a_{i+1,i+1}=a_{i+1,i+1}−a_{i+1,i}×(a_{i,i+1}/a_{i,i}). By the =a_{i+1,i+1} permutations and update, the absolute value of the element a_{i+1,i+1} is expected to take a sufficiently large value to be a pivot.

<Application of Delayed Pivoting to Supernodal Approach>

Let us consider the case of implementing delayed pivoting during matrix factorization using a supernodal approach, which is a direct method to solve simultaneous linear equations with a sparse matrix. In the supernodal approach, pivots are selected in the diagonal block of each supernode. Therefore, by moving target rows and columns to the end of its parent supernode in dependencies, suitable pivots are selected after appropriate reordering. As a result of transferring the rows and columns in delayed pivoting to the end of its parent supernode, the transferred rows and columns undergo updates based on results of the LU factorization of the parent supernode.

In the direct method used to solve simultaneous linear equations with a sparse matrix, fill-in and dependencies induced by factoring the sparse matrix are determined before the factorization. This step is called symbolic factorization. Each column composed of nonzero elements whose row numbers are larger than the row number of its diagonal element is referred to as a “node”. Then, using such information, adjacent columns with nearly identical nonzero patterns are grouped together to form each supernode.

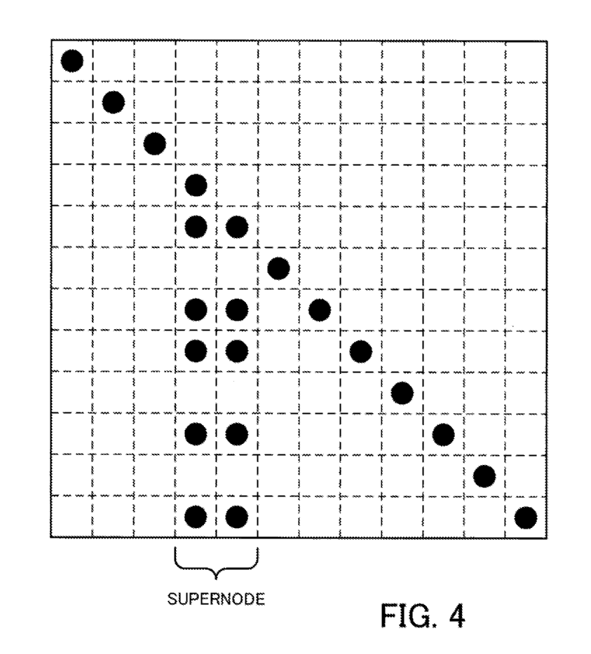

FIG. 4 illustrates a supernode. A supernode is a contiguous set of columns whose nonzero structure consists of a dense triangular block in the diagonal and an identical set of nonzeros in each column below the diagonal block. Within rows sharing the diagonal elements of nodes constituting a supernode, part of the rows each consisting of elements whose column numbers are larger than the row number of the diagonal element is referred to as rows corresponding to the supernode. Then, by grouping the rows corresponding to each supernode together, columns and rows corresponding to the supernode are determined. Then, the computer 100 stores results of the LU factorization for each supernode separately in a panel for collectively storing columns and a panel for collectively storing rows. These panels may be viewed as two-dimensional arrays. Note that the computer 100 stores the diagonal block in the panel for the columns.

The computer 100 performs symbolic factorization to determine the size of a storage area for the results of the LU factorization of each supernode. Then, prior to the numerical factorization, the computer 100 assigns a storage area to the supernode according to the determined size. Subsequently, the numerical factorization is performed. In order to provide stability of the numerical factorization, the computer 100 implements delayed pivoting.

<Issues Associated with Application of Delayed Pivoting to Supernodal Approach>

For general matrices, an algorithm has been developed which achieves column permutations in such a manner that elements with large values are aligned on the diagonal. The algorithm converts a matrix to be almost diagonally dominant prior to the LU factorization. There is a technique known as threshold pivoting, which accepts an element as a pivot if the absolute value of the element exceeds a certain threshold. When the threshold pivoting strategy is applied to a matrix being diagonally dominant, it is often the case that, in pivot search, a pivot is found in the vicinity. However, application of this preprocessing to a structurally symmetric matrix or symmetric indefinite matrix undermines the symmetry property of the original matrix, which therefore makes the use of the original symmetry impossible. For this reason, delayed pivoting is regarded as a key technique to provide stability while maintaining the symmetry of the original matrix. The term “structurally symmetric” here refers to nonzero elements being symmetric along the diagonal.

In the supernodal approach for a general real matrix, pivot search is performed within each supernode. If the pivot search is not successful, static pivoting is employed, which replaces a pivot by a numerical value of an appropriate magnitude (a magnitude of about 1.0D-8 to 1.0D-10 in the case of double precision real numbers, i.e., the precision being reduced by approximately 50%), to compute an approximate factorization. Because the accuracy of the factorization is reduced in the process, the solution is improved through iterative refinement with higher precision (for example, using quadruple-precision numbers in the case of double precision real numbers). One approach to computing LU factorization of a general real matrix A is to build an elimination tree associated with A+A^{T} containing the matrix A. Incorporating delayed pivoting not undermining the symmetry property of the matrix into this approach is expected to produce positive effects. That is, better performance is expected with a fewer number of refinement iterations without causing accuracy loss in the factorization.

Application of delayed pivoting to a direct method for solving simultaneous linear equations with a sparse matrix causes dynamic changes in matrix elements constituting each supernode, and moving rows and columns to later positions involves an increase in the area for storing the elements of these rows and columns. Further, the exact increment in the storage area is known only when delayed pivoting is actually implemented. Therefore, the size of the storage area needs to be dynamically calculated, and then allocation or release of storage space is made according to the calculated results. In fact, in a multifrontal method, intermediate results of the factorization are temporarily stored in a dynamically allocated area, and columns and rows to be factored are assembled for each step in the factorization while taking a closer look at dependencies. Therefore, the multifrontal method often needs a large amount of memory and has high computation complexity.

In the supernodal approach, symbolic factorization is performed before numerical factorization to analyze dependencies among nodes, which are expressed by a tree structure. The tree structure is used in the subsequent numerical factorization. Then, the symbolic factorization computes the size of an area for storing results of the numerical factorization, and assigns the calculated storage area before the numerical factorization takes place. However, application of delayed pivoting involves dynamic changes in the storage area usage, which results in dynamic management of almost all the memory and, therefore, very high computational burden.

<Dependencies Among Supernodes>

The second embodiment aims at a viable processing scheme used in running simulations or solving mathematical programming problems to preliminarily assign a storage area by making the best use of information obtained from symbolic factorization and then analyze a tree structure representing dependencies. Before functions of the second embodiment are described, an overview of an elimination tree and row subtrees used to determine dependencies among supernodes will be given next.

The LL^{T} factorization of a sparse symmetric positive matrix uses an elimination tree and row subtrees. Note that the use of an elimination tree and row subtrees is applicable also to structurally symmetric real matrices and symmetric indefinite matrices. Here, the elimination tree and row subtrees used in the LL^{T} factorization of a sparse symmetric positive matrix are described.

An elimination tree representing dependencies among individual columns of a matrix L obtained by factorization is determined from the nonzero pattern of a sparse symmetric positive matrix P. The matrix P is factored as P=LL^{T} using Cholesky factorization. When an element in row i and column j of the matrix L is denoted by Lᵢⱼ, the parent of j satisfies the following relation: parent[j]=min{i|i>j, Lᵢⱼ≈0}.

The top-most node having no parent in the elimination tree is referred to as the “root” node. When p is the parent of a node q, the node q is referred to as a child node of the parent p. Numbers obtained through a depth-first search from the root node of the elimination tree are called “postorder” numbers. The depth-first search from the root node arrives at a node not partitioned any further in the elimination tree, which is referred to as “leaf” node. Each leaf node is associated with individual nodes visited when the elimination tree is traversed from the leaf node up to the root node through parent nodes. When a plurality of leaf nodes are associated with a given node, one assigned the smallest postorder number among the leaf nodes is referred to as the “first descendant” of the node.

When column j in the lower triangular matrix of the original symmetric positive matrix is denoted by bⱼ, the nonzero pattern of the matrix L is the union of bⱼ and a column lₖ of L, which is a child node of j. Based on this concept, nonzero elements in row i of L are represented as a subtree of the elimination tree. This subtree is a row subtree having the i^{th} node as its root node.

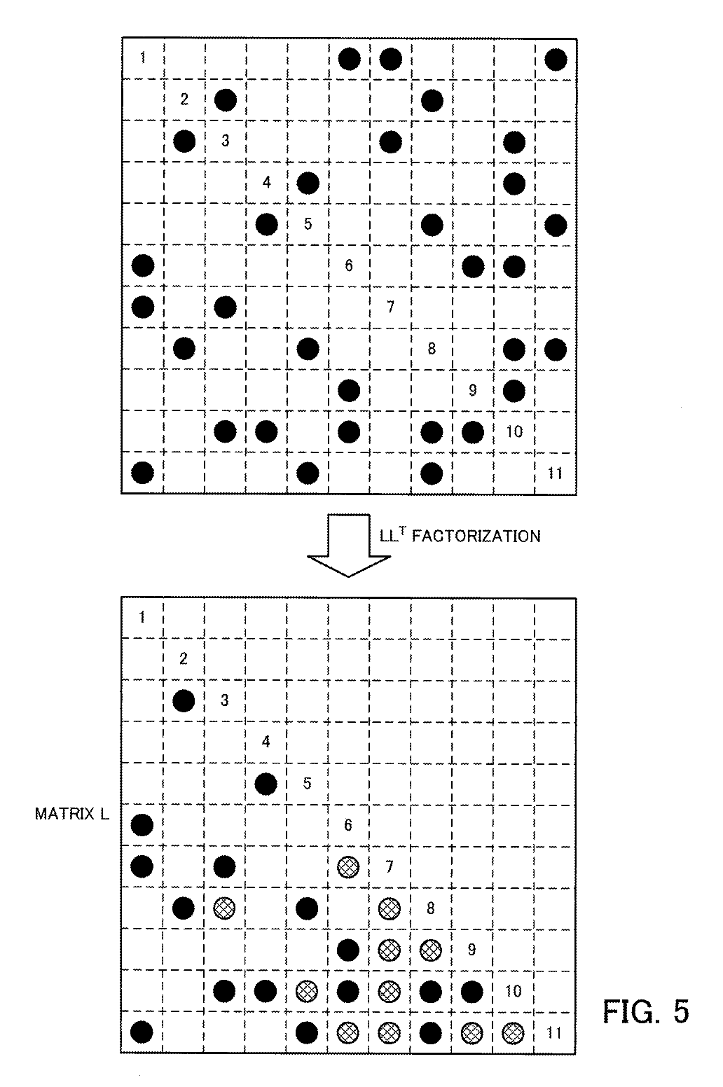

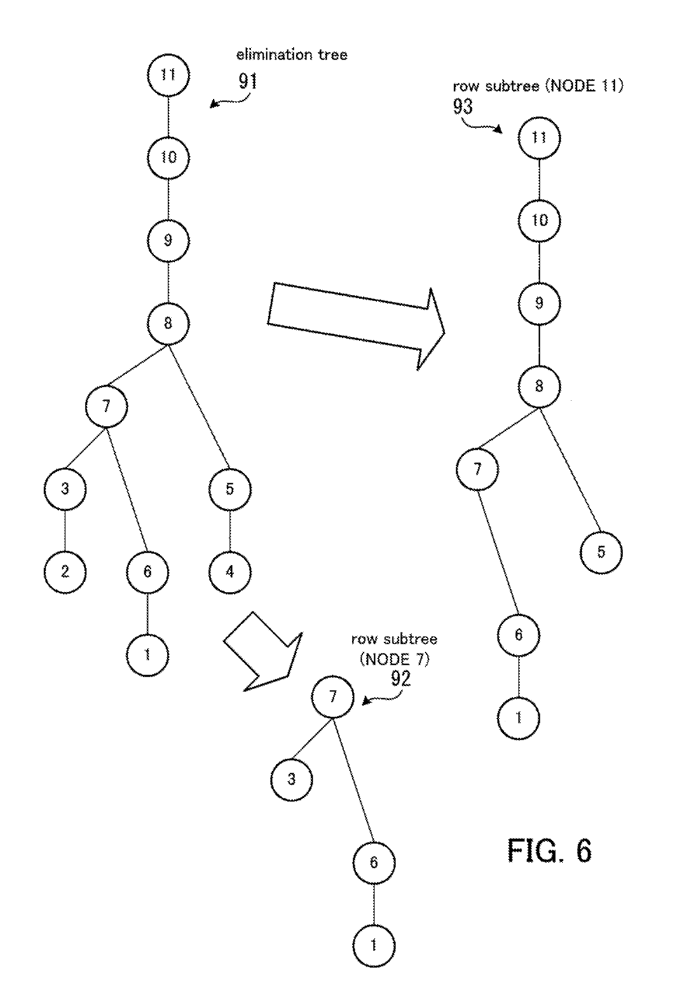

Next described is a specific example of an elimination tree and row subtrees obtained as a result of the LL^{T} factorization of a symmetric positive matrix, with reference to FIGS. 5 and 6. FIG. 5 illustrates an example of the LL^{T} factorization. The upper section of FIG. 5 illustrates a matrix before the factorization and the lower section illustrates a lower triangular matrix L obtained by the factorization. In each of the diagonal elements of the individual matrices, the row number of the diagonal element is indicated. Assume here that the diagonal elements of these matrices are nonzero.

In the matrix before the factorization, nonzero elements are denoted by black circles. When the LL^{T} factorization of the matrix is performed, new nonzero elements are added to the lower triangular matrix L after the factorization. These new nonzero elements created by the factorization are denoted in FIG. 5 by hatched circles. Based on the lower triangular matrix (the matrix L) obtained from the LL^{T} factorization, an elimination trees and row subtrees are generated.

FIG. 6 illustrates an example of the generated elimination tree and row subtrees. For example, in the first column (j=1) in the matrix L of FIG. 5, min{i|i>j, Lᵢⱼ≈0} is 6. In this case, the parent node of Node 1 is Node 6. Similarly, the parent node of Node 2 is Node 3. Such a parent-child relationship is determined for every column in the matrix L, and the nodes are connected by branches in such a manner to represent the determined parent-child relationships to thereby construct an elimination tree 91 illustrated in FIG. 6.

The order in which the depth-first search visits the nodes of the elimination tree 91 is as follows: 2→3→1→6→7→4→5→8→9→10→11. Then, postorder numbers are assigned to the individual nodes according to the depth-first search order. Referring back to FIG. 5, nonzero elements are located in {1, 3, 7} on row 7 in the matrix before the factorization. In the elimination tree 91 of FIG. 6, Node 1 is a leaf node and the path from Node 1 is traced back to Node 7. The path from Node 3 is traced back to Node 7. As a result, a subtree {1, 6, 3, 7} is extracted from the elimination tree 91 to form a row subtree 92 with Node 7 as the root node. In the row subtree 92, Nodes 1 and 3 are leaf nodes.

In like fashion, a row subtree 93 with Node 11 is formed. Nonzero elements, except for the diagonal element, are located in {1, 5, 8} on the row with row number “11” in the matrix before the factorization. When these nonzero elements are taken out in a postorder sequence, the order stays the same, i.e., 1→5→8. The first descendants of Nodes 1, 5, 8 are Nodes 1, 4, 2, respectively. Node 1 is first and therefore a leaf node. The postorder number of Node 4, which is the first descendant of Node 5, is larger than the postorder number of Node 1, and therefore Node 4 is located on a different branch below a branch node (a depth-first search first visits leaf nodes before branch nodes). Because the postorder number of Node 2, which is the first descendant of Node 8, is smaller than the postorder number of Node 5, Node 2 is located on the original branch below the branch node, and there is no branching between Nodes 5 and 8.

Thus, the nonzero elements of each row in the matrix before the factorization are taken out in the postorder sequence, and the postorder number of a node taken out the last time is compared with the postorder number of the first descendant of a node currently taken out. If the postorder number of the first descendant of the current node is larger, the current node is a leaf node of the row subtree. That is, because the postorder numbers have been assigned according to the depth-first search order, the postorder number of the first descendant of the current node becomes larger when branching takes place at a common ancestor of the current node and the previous node. The same results will be obtained by taking out nonzero elements of each row in the postorder sequence, then remembering the previous leaf node instead of the previous node, and making an update when a new leaf node is found.

The row subtree indicates nonzero elements of each row. In the case of a real matrix with nonzero elements being structurally symmetric, the row subtree also indicates nonzero elements of a column in the matrix U, located symmetrically to each row in the matrix L. It is known that, within the matrix L, columns used to update a column corresponding to each node in the postorder sequence (as well as, within the matrix U, rows used to update a row corresponding to each node in the postorder sequence) are those corresponding to nodes included in the row subtree of the node.

Such is the case with supernodes, each consisting of nodes corresponding to a contiguous set of columns of the matrix L with nearly identical nonzero patterns. That is, when each supernode being a set of a plurality of nodes is viewed as a single node, tree structures representing dependencies among supernodes are generated by the same procedures described in FIGS. 5 and 6. The tree structures representing dependencies among supernodes generated by the same procedures as those for the above-described elimination tree and row subtrees are referred to as supernodal elimination tree and supernodal row subtrees.

<Functions of Computer>

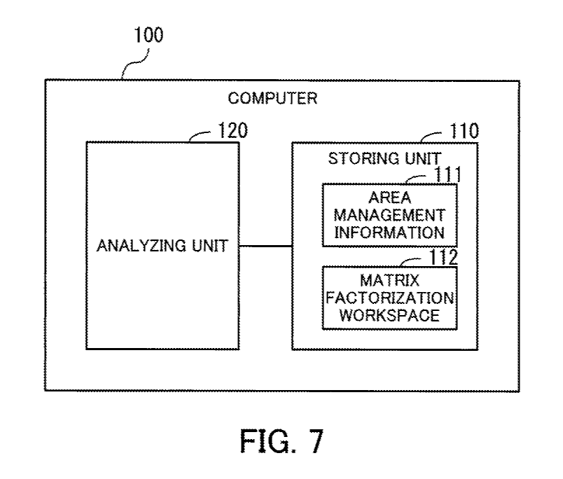

FIG. 7 is a block diagram illustrating functions of the computer. The computer 100 includes a storing unit 110 and an analyzing unit 120. The storing unit 110 stores therein area management information 111 as well as a matrix factorization workspace 112 for calculation involved in matrix factorization. The area management information 111 is management information indicating, for example, the size of the matrix factorization workspace 112. The matrix factorization workspace 112 is a storage area for storing elements during factorization of each supernode.

The analyzing unit 120 executes various analytical processing involving the solution to simultaneous linear equations. For example, the analyzing unit 120 runs simulation for fluid analyses, for example. In the analytical processing, the analyzing unit 120 performs LU or LDL^{T} factorization of a sparse matrix in order to solve simultaneous linear equations.

Note that the function of each component illustrated in FIG. 7 is implemented, for example, by causing a computer to execute a program module corresponding to the component. Of the individual components of FIG. 7, the analyzing unit 120 is an example of a functional component incorporating the parent-child relationship determining unit 12, the first storage area allocating unit 13, the first factoring unit 14, the second storage area allocating unit 15, and the second factoring unit 16 of FIG. 1. In addition, the storing unit 110 of FIG. 7 is an example of the storing unit 11 of FIG. 1.

<LU Factorization of Structurally Symmetric Sparse Real Matrix>

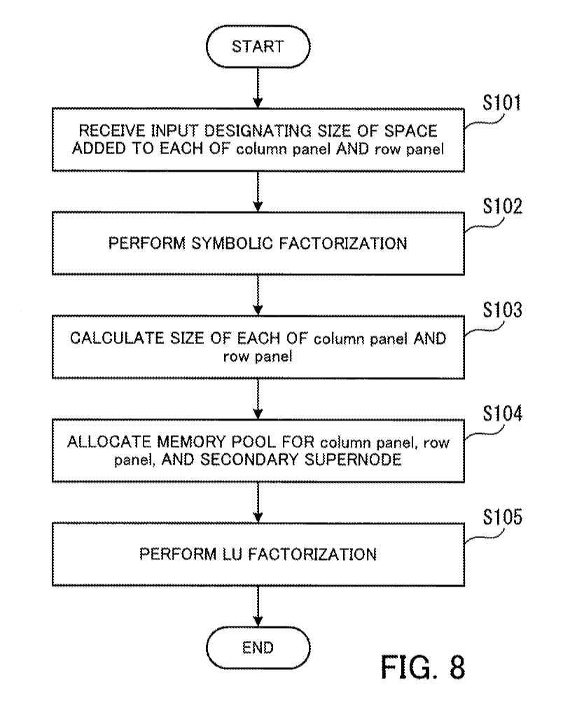

Next described is LU factorization of a structurally symmetric sparse real matrix. FIG. 8 is a flowchart illustrating a procedure of LU factorization of a structurally symmetric sparse real matrix. The process of FIG. 8 is described next according to the step numbers in the flowchart.

[Step S101] The analyzing unit 120 receives an input designating the size of a space added to each of the column and row panels. For example, the analyzing unit 120 acquires a value indicating the size of the space, input by the user via an input device, e.g., the keyboard 22.

[Step S102] The analyzing unit 120 performs symbolic factorization. The symbolic factorization achieves generation of an elimination tree, detection of supernodes, and generation of supernodal row subtrees.

[Step S103] For each of the column panel and the row panel, the analyzing unit 120 calculates the size of the panel with the added space.

[Step S104] The analyzing unit 120 allocates, in the memory 102, a memory pool used to assign a column-panel area, a row-panel area, and a secondary supernode area.

[Step S105] The analyzing unit 120 performs LU factorization. In the LU factorization, the analyzing unit 120 uses the spaces prepared for transferring pivots to be delayed (hereinafter referred to as “delayed pivots” for the sake of simplicity). In the case where the count of delayed pivots to be transferred exceeds the size of the spaces, the analyzing unit 120 creates a secondary supernode and stores rows and columns corresponding to delayed pivots being left out.

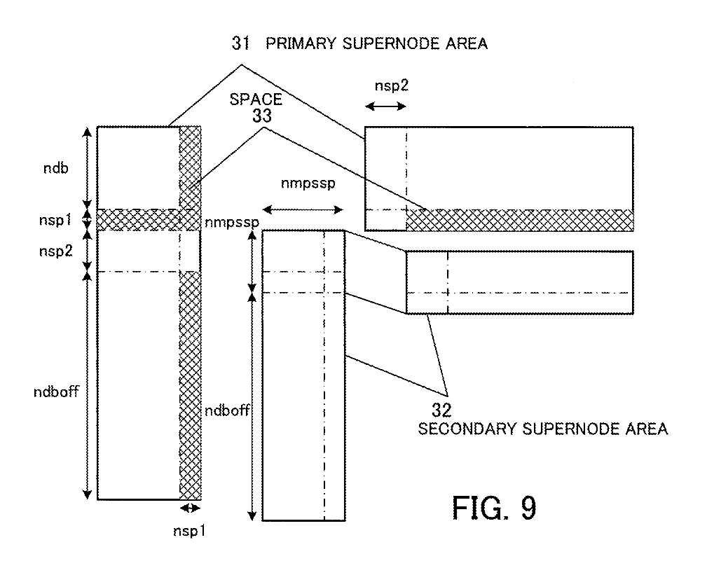

The LU factorization is achieved by the above-described procedure. Next, effective use of the memory 102 in the LU factorization is described in detail. In the case of performing LU factorization of a structurally symmetric sparse real matrix, elements of each supernode are stored in a storage area called panels. FIG. 9 illustrates an example of panel configurations used in the LU factorization of a structurally symmetric sparse real matrix. FIG. 9 depicts a panel configuration of a primary supernode area 31 for storing factorization results of a primary supernode and a panel configuration of a secondary supernode area 32 for storing factorization results of a secondary supernode.

The analyzing unit 120 adds spaces 33 for delayed pivots to the size of each supernode obtained by the symbolic factorization. Specifically, the analyzing unit 120 provides the space 33 for each of a column panel for collectively storing columns and a row panel for collectively storing rows. The panels are two-dimensional, and each of the spaces 33 is provided both in the first and second dimensions.

The maximum count of delayed pivots allowed to be transferred to the storage panels of the primary supernode area 31 is denoted by nsp1. The maximum count associated with the second dimensional size of the storage panels of the secondary supernode area 32 to be dynamically allocated when the spaces of nsp1 run out is denoted by nsp2. The size to be dynamically allocated corresponds to the count (nmpssp) obtained by subtracting nsp1 from the count of delayed pivots to be transferred to the back of the primary supernode area 31. That is, when nmpssp is smaller than nsp2, the processing is able to be continued. Note that, within the secondary supernode area 32, the analyzing unit 120 allocates spaces of nsp3=nsp1+nsp2 in the first dimension.

Information indicating the panel configurations illustrated in FIG. 9 is stored in the storing unit 110 as the area management information 111. Then, the panels and information associated with the panels are stored in the matrix factorization workspace 112. The information associated with the panels includes indices of nonzero elements (index vectors) and information on pivot exchanges within each supernode (exchange history).

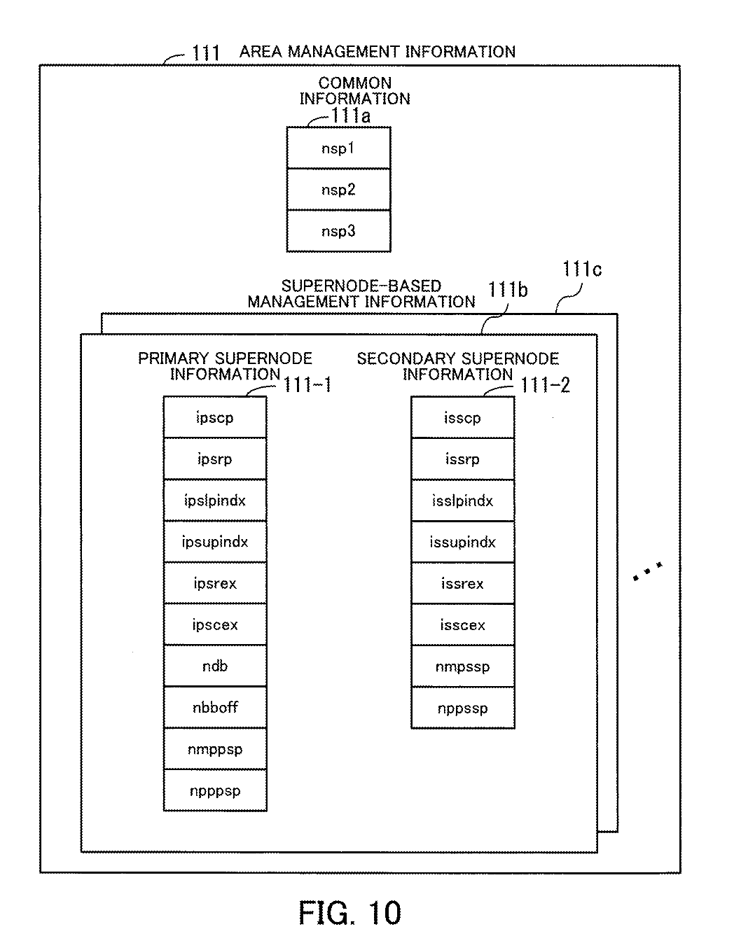

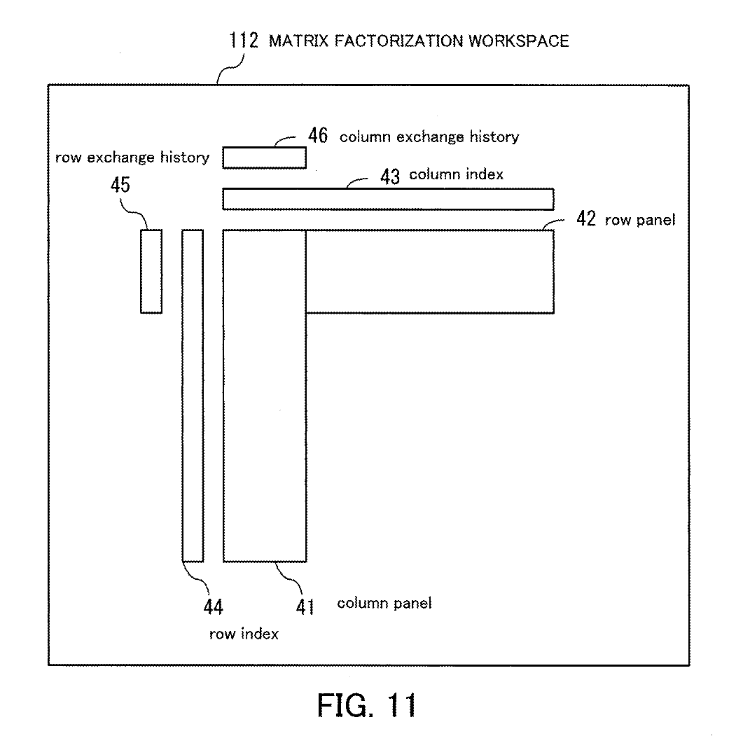

Next, the area management information 111 and the matrix factorization workspace 112 of the storing unit 110 are described in detail with reference to FIGS. 10 and 11. FIG. 10 illustrates an example of the area management information. The area management information 111 includes common information 111a and supernode-based management information 111b, 111c, and so on. Note that, in FIG. 10, “psp” and “ssp” included in each data name denote primary and secondary supernode, respectively. The common information 111a includes nsp1, nsp2, and nsp3.

The supernode-based management information 111b, 111c, and so on individually includes primary supernode information 111-1 and secondary supernode information 111-2. The primary supernode information 111-1 includes ipscp, ipsrp, ipslpindx, ipsupindx, ipsrex, ipscex, ndb, nbboff, nmppsp, and npppsp. ipscp is an index indicating the column panel of the primary supernode. ipsrp is an index indicating the row panel of the primary supernode. ipslpindx is an index indicating an index list of the column panel of the primary supernode. ipsupindx is an index indicating an index list of the row panel of the primary supernode. ipsrex is the history of row exchanges of the primary supernode. ipscex is the history of column exchanges of the primary supernode. ndb is the size of the supernode determined in the symbolic factorization. nbboff is the size of the supernode determined in the symbolic factorization, excluding the diagonal elements. nmppsp is the count of delayed pivots transferred to the primary supernode. npppsp is the count of nodes remained in the primary supernode as pivots.

The secondary supernode information 111-2 includes isscp, issrp, isslpindx, issupindx, issrex, isscex, nmpssp, and nppssp. isscp is an index indicating the column panel of the secondary supernode. issrp is an index indicating the row panel of the secondary supernode. isslpindx is an index indicating an index list of the column panel of the secondary supernode. issupindx is an index indicating an index list of the row panel of the secondary supernode. issrex is the history of row exchanges of the secondary supernode. isscex is the history of column exchanges of the secondary supernode. nmpssp is the count of delayed pivots transferred to the secondary supernode. nppssp is the count of nodes remained in the secondary supernode as pivots.

FIG. 11 illustrates a data structure example of the matrix factorization workspace. In the matrix factorization workspace 112, the following areas are provided for each primary supernode: a column panel 41; a row panel 42; a column index 43; a row index 44; a row exchange history 45; and a column exchange history 46. Each of the areas includes an area corresponding to the spaces 33. Indices indicating the locations of these six areas for each supernode are individually stored in their corresponding one-dimensional arrays nofstcp, nofstrp, noftstcindx, nofstrindx, nofstrcx, and nofstrex. When the total count of supernodes is numsp, the size of each one-dimensional array is (numsp+1). In the (numsp+1)^{th} entry of the one-dimensional array, a value obtained by adding 1 to the size of the area is set.

When not all delayed pivots to be transferred to a supernode fit in the primary supernode, a secondary supernode is generated. Also for the generated secondary supernode, the areas illustrated in FIG. 11 are provided. The size of the secondary supernode corresponds to the size obtained by adding the count of delayed pivots that did not fit in the primary supernode and are therefore left out together with the count of delayed pivots produced by the factorization (LU or LDL^{T} factorization) of the panels of the primary supernode.

Data on the secondary supernode is stored in a memory pool (a storage area reserved in the memory 102), separately from data on the primary supernode. The size of the entire memory pool is preliminarily designated by the user. The storage area for the secondary supernode is assigned from the preliminarily allocated memory pool. Each area of FIG. 11 is identified by an index indicating its offset from the beginning of the memory pool. Assigning, for example, the postorder number of the primary supernode to each of the indices allows them to be identifiable.

It is possible to hold information on locations, or the like, of the individual data storage areas for the primary and secondary supernodes, for example, using two-dimensional arrays, in each of which the second dimension designates a supernode and the first dimension is used to store corresponding information.

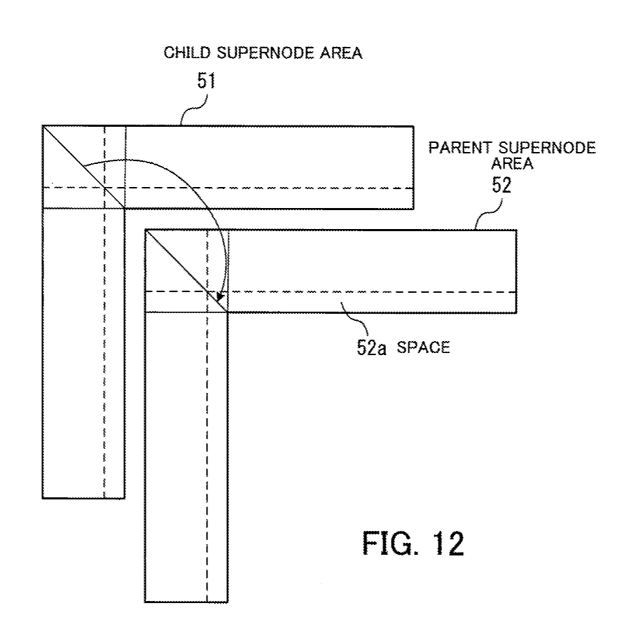

Next described are supernodes in dependencies. According to the second embodiment, rows and columns corresponding to delayed pivots are transferred from a child supernode to a parent supernode having a dependency relationship with the child supernode. FIG. 12 illustrates transfer of rows and columns between supernodes. Rows and columns sharing diagonal elements determined to be delayed pivots in a child supernode area 51 are transferred to spaces 52a of a parent supernode area 52. For example, in the case where the last node (with the largest column number) of the child supernode becomes a transfer target of delayed pivoting, it is not possible to move the node to a later position within the child supernode, and the node is, therefore, transferred to the parent supernode. In this case, the count of nonzero elements in the parent supernode area 52 increases. Note that since there is no dependency between the child supernode and its sibling supernode, the count of nonzero elements in the sibling supernode remains unchanged.

Note here that the maximum count of delayed pivots allowed to be transferred to a supernode determined in symbolic factorization from its child supernode is nsp1+nsp2. In addition, if the count of delayed pivots to be transferred from the child supernode exceeds nsp1, a secondary supernode is generated and rows and columns corresponding to delayed pivots being left out are transferred to the secondary supernode. The size of the secondary supernode corresponds to the size obtained by adding the count of the delayed pivot being left out together with the count of delayed pivots produced in the primary supernode.

The validity of the space allocation in the above-described manner will be seen from the following. In the example of FIG. 3 above, row and column i are transferred to the back of row and column j. Now let us consider transferring row and column i to the back of row and column j in consideration of a submatrix of A(i-n, i-n). This transfer is an operation of transferring the last row and column (row and column i) of an immediate predecessor child supernode to the back of its parent supernode consisting of rows and columns i+1 to j. In this regard, the transferred row and column are stored in the spaces of the row panel and the column panel, respectively, in the destination parent supernode. An increase in the count of delayed pivots transferred leads to an increase in the space usage. Therefore, by transferring delayed pivots to the end of the parent supernode, it is easily understood the size of each space needed to be allocated because it corresponds to the count of the transferred delayed pivots. In addition, when transfer is made to a succeeding supernode through a supernode formed by the transferred delayed pivots, the size of space needed to be allocated corresponds to the count of the transferred delayed pivots.

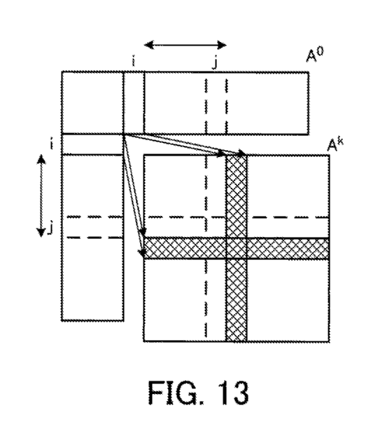

Next, the transfer of delayed pivots is described in detail. FIG. 13 illustrates an example of transferring a delayed pivot. The part transferred by symmetric permutations is denoted as hatched area in FIG. 13. The transferred part is located, within the source supernode, along the lower edge in the vertical direction and the right-hand edge in the lateral direction. That is, the transfer of the delayed pivot is limited, within an original matrix A⁰, to a submatrix A^{k} with row i and subsequent rows and column i and subsequent columns. Thus, transferring row and column corresponding to the delayed pivot while limiting the transfer destination to the submatrix reduces storage requirements and improves processing efficiency.

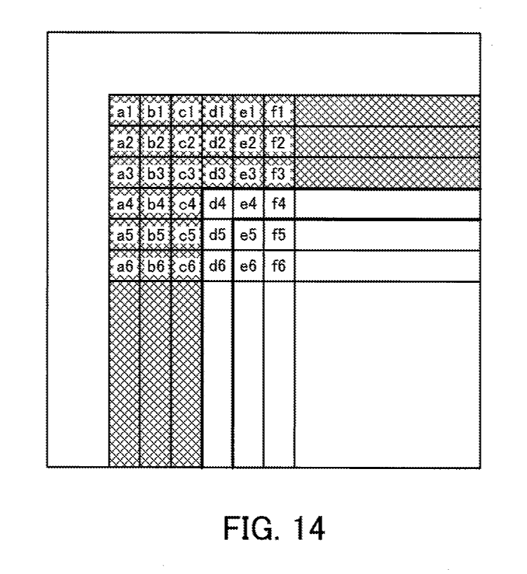

Next described are movements of delayed pivots containing a plurality of blocks. FIG. 14 illustrates an example of delayed pivots to be transferred. In FIG. 14, three delayed pivots of diagonal blocks a1, b2, and c3 are produced by the factorization of a first supernode. Assume here that the rows and columns sharing the delayed pivots of the diagonal blocks a1 and b2 are transferred to the spaces of the primary supernode, which is a supernode with a diagonal block d4. Assume also that the row and column sharing the delayed pivot of the diagonal block c3 are also transferred and then stored in a secondary supernode.

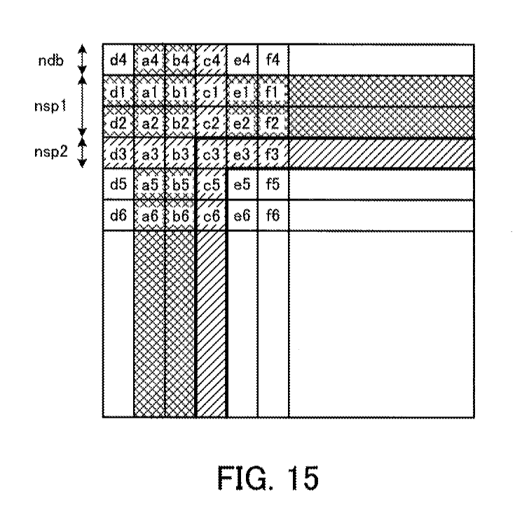

FIG. 15 illustrates a supernode to which the delayed pivots are transferred. In the example of FIG. 15, the rows and columns of the delayed pivots of the diagonal blocks a1 and b2 are transferred to the primary supernode with the diagonal block d4. The row and column of the delayed pivot of the diagonal block c3 does not fit in the primary supernode and is therefore stored in the secondary supernode. As illustrated in FIG. 15, the elements of the transfer targets are all fit in the area corresponding to a combination of the size of the supernode, ndb, obtained from the symbolic factorization, the space of nsp1, and the space of nsp2 which is the size of the secondary supernode.

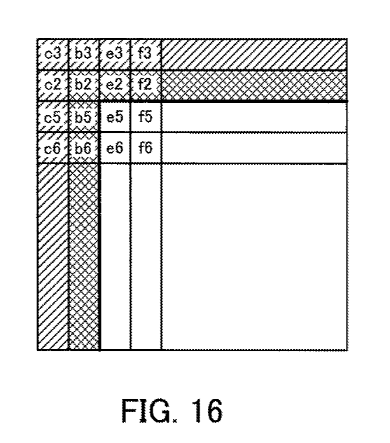

Now assume the case where the diagonal block b2 is determined to be a delayed pivot by the factorization of the primary supernode. In this case, the row and column sharing the diagonal block b2 are transferred to the back of the rows and column of the delayed pivot of the diagonal block c3. FIG. 16 illustrates an example of transferring a delayed pivot produced by the factorization of the primary supernode. In the example of FIG. 16, the secondary super node is generated for the left-out delayed pivot (the diagonal block c3) and the delayed pivot produced by the factorization of the primary node (the diagonal block b2). Then, the rows and columns corresponding to the delayed pivots of the diagonal blocks c3 and b2 are stored in the generated secondary supernode. In this manner, it is possible to make efficient use of the memory 102 in matrix factorization by applying delayed pivoting to the supernodal approach.

<Specific Procedure for LU Factorization>

Let us consider the case of performing LU factorization of a structurally symmetric sparse real matrix. Nonzero elements in the factorization target matrix are arranged symmetrically along the main diagonal and, therefore, dependencies in the factorization of individual nodes are represented by an elimination tree. Also as for asymmetric real matrixes, it is possible to see dependencies in the factorization in view of a symmetric matrix where A⊂A+A^{T}. Therefore, we provide a description here using a structurally symmetric real matrix.

The analyzing unit 120 forms each supernode by grouping nodes in parent-child relationships with nearly identical nonzero patterns. Then, the analyzing unit 120 generates an elimination tree representing dependencies among the supernodes, which is referred to as the supernodal elimination tree. Further, as in the case of an elimination tree, the analyzing unit 120 assigns postorder numbers to the individual supernodes according to the depth-first search order. Let us consider now a factored matrix L. Supernodes that are sets of columns and correspond to parts where nonzero elements are present form a supernodal row subtree, which is an equivalent of a row subtree.

The analyzing unit 120 uses row and column panels to store nonzero elements of nodes making up a supernode and nonzero elements of nodes with node numbers larger than those of the nodes making up the supernode. The row panel stores rows in a transposed manner. In order to obtain the numbers associated with the nonzero elements to be stored, one-dimensional array as an index list is provided for each of the row and column panels.

In the case of factoring each node with no consideration for delayed pivoting, node factorization is performed in the following order: [1] the analyzing unit 120 takes out each supernode in the postorder sequence and repeats the following steps [2] and [3]; [2] the analyzing unit 120 updates the values of elements in the selected supernode according to contributions from the supernodal row subtree; and [3] after the updates, the analyzing unit 120 performs LU factorization of the column panel of the supernode.

Note that each column panel of the matrix L includes diagonal blocks of the matrix U. The analyzing unit 120 updates the row panel of the updated matrix U using factorization results of the diagonal blocks, obtained from the LU factorization of the column panel of the matrix L.

On the other hand, the factorization process incorporating delayed pivoting is as follows. The analyzing unit 120 determines pivots in LU factorization of each supernode. Note that the analyzing unit 120 chooses pivots only from the diagonal block elements of the supernode. In the case of, for example, a diagonal pivoting strategy which selects the largest diagonal element of the supernode as a pivot, no appropriate pivot is available when the absolute value of such a diagonal element falls below a predetermined value or becomes zero. In such a case, using results obtained from rows and columns for which the LU factorization is completed, the analyzing unit 120 updates the remaining rows and columns for which no pivots are available. Subsequently, the analyzing unit 120 performs symmetric permutations to transfer the rows and columns with no pivots found to the back of the parent supernode of the supernode currently being factored. Note that the analyzing unit 120 preliminarily provides spaces for the transfer to the parent supernode.

As a result of selecting a pivot within diagonal blocks of a supernode and permuting rows and columns in the above-described manner, switching of row and column indices takes place with the permuted rows and columns. Therefore, the analyzing unit 120 reflects results of the row and column permutations to the indices. That is, when delayed pivots are transferred, the analyzing unit 120 also transfers the indices of rows and columns corresponding to the transferred pivots. As for an index list representing the nonzero pattern of the child supernode for a part consisting of diagonal blocks and elements below them within the column panel of the parent supernode, the index list at the time of the transfer indicates the same as the nonzero pattern of the parent supernode.

The analyzing unit 120 performs LU factorization of each supernode in the postorder sequence. In the LU factorization of the supernode, the analyzing unit 120 first updates the row and column panels. In this regard, the analyzing unit 120 calculates contributions from supernodes constituting the supernodal row subtree of the supernode, and updates the values of the elements. Note that the supernodes constituting the supernodal row subtree undergo changes in block width (the count of rows and columns) when delayed pivots are transferred; however, there is no change in the range of node numbers of nodes used to update the panels of the parent supernode.

In the case of a structurally symmetric real matrix, the analyzing unit 120 calculates updates of a factorization-target supernode in the following procedure.

[1] The analyzing unit 120 takes out each constituent supernode from the supernodal row subtree of the target supernode and repeats the following steps [1.1] and [1.2] until all the constituent supernodes are taken out. In this regard, the analyzing unit 120 treats a secondary supernode of each constituent supernode of the supernodal row subtree as a constituent of the supernodal row subtree.

[1.1] The analyzing unit 120 updates the column panel. Details of this step are presented in the column panel update procedure (a.1 to a.4) to be described below.

[1.2] The analyzing unit 120 updates the row panel, as with [1.1].

[2] The analyzing unit 120 transfers delayed pivots and performs LU factorization.

[2.1] The analyzing unit 120 calculates the total count of delayed pivots transferred from a child of the target supernode, “numdp”. Then, the analyzing unit 120 takes delayed pivots to fit in the spaces out of numdp and puts them into the spaces.

[2.2] The analyzing unit 120 performs LU factorization.

[2.3] If delayed pivots are produced by the LU factorization of the target supernode, the analyzing unit 120 updates the delayed pivots using results of the LU factorization. For example, rows and columns of nodes corresponding to the delayed pivots are transferred.

[2.4.1] The analyzing unit 120 allocates a secondary supernode sufficient to accommodate remaining pivots of numdp, “restdp”, which did not fit in the spaces, if any, and the delayed pivots produced in [2.3]. The analyzing unit 120 then transfers the appropriate delayed pivots to the secondary supernode. Subsequently, the analyzing unit 120 updates restdp using the results of the LU factorization of the target supernode.

[2.4.2] The analyzing unit 120 performs LU factorization of the secondary supernode. If delayed pivots are produced by the factorization, the analyzing unit 120 updates these delayed pivots using results of the factorization. For example, rows and columns of nodes corresponding to the delayed pivots are transferred.

The procedure for calculating updates of each supernode has been described thus far. Next, the column panel update procedure (a.1 to a.4) is described in detail.

[a.1] The analyzing unit 120 transposes rows of nodes belonging to the supernode, except for the diagonal blocks, to form a row panel. The analyzing unit 120 stores the row panel in a two-dimensional array, rpanel(nr1, nr2).

[a.2] The analyzing unit 120 copies, amongst columns stored in the row panel, columns with column numbers of the supernode to be updated to a working matrix B(nr1, len). len represents the count of columns copied. Within the column panel, the analyzing unit 120 finds the top (“ntop”) of nodes to be updated, identified by their node numbers. The column panel is a two-dimensional array, cpanel(nc1, nc2).

[a.3] The analyzing unit 120 calculates a matrix C(nc1−ntop+1, len)←cpanel(ntop-nc1, nc2)×B(nr1, len). Note here that nc2 is equal to nr1.

[a.4] The analyzing unit 120 updates each column of the matrix C by subtracting each element of the column from an element of the supernode, having the same row and column numbers as those of the element of the column to be updated.

As for updates of the row panel of a structurally symmetric real matrix, the calculation is made by swapping the column panel and the row panel.

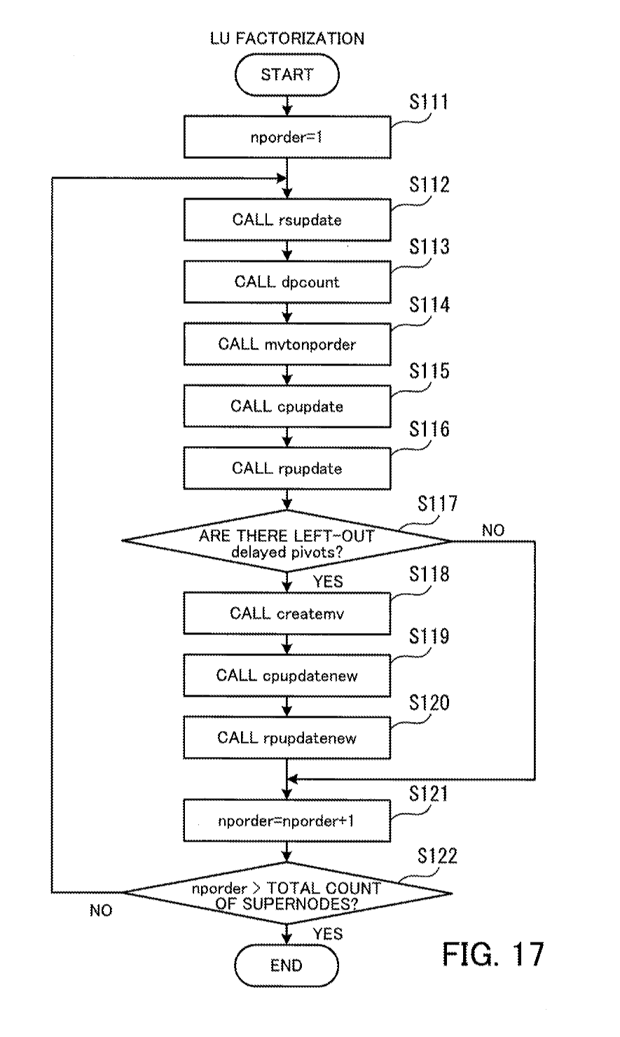

Next, details of the process of implementing delayed pivoting with the allocation of extra spaces and performing LU factorization are described with reference to flowcharts of FIGS. 17 to 25. FIG. 17 is a flowchart illustrating a procedure of LU factorization. The process of FIG. 17 is described next according to the step numbers in the flowchart.

[Step S111] The analyzing unit 120 sets “nporder” to 1. nporder is a number indicating a processing-target supernode. That is, supernodes included in a factorization-target matrix are assigned identification numbers in ascending sequence, starting with 1. Then, a supernode with an identification numbers indicated by nporder is the target of the current processing.

[Step S112] The analyzing unit 120 calls a subroutine called “rsupdate” and then executes the subroutine.

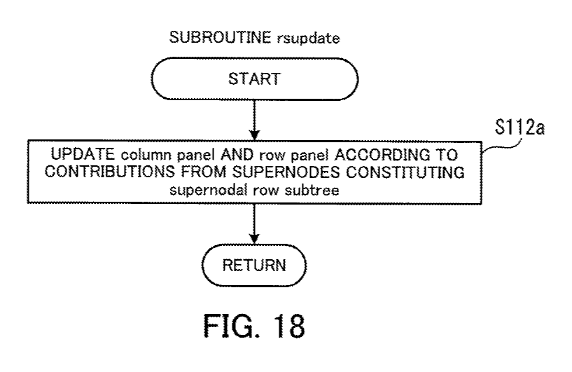

FIG. 18 is a flowchart illustrating processing of subroutine rsupdate. The analyzing unit 120 updates the row and column panels according to contributions from supernodes constituting the supernodal row subtree of the supernode with nporder, except for the supernode with nporder. The analyzing unit 120 updates the row and column panels including nodes newly created, if any (step S112a). Subsequently, the analyzing unit 120 returns to the LU factorization process (FIG. 17).

[Step S113] The analyzing unit 120 calls a subroutine called “dpcount” and then executes the subroutine.

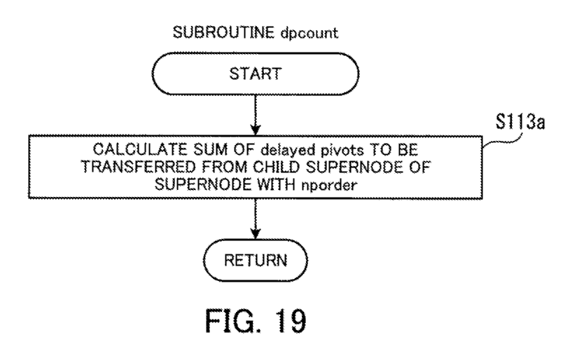

FIG. 19 is a flowchart illustrating processing of subroutine dpcount. The analyzing unit 120 calculates the sum of delayed pivots to be transferred to the supernode with nporder from its child supernode (step S113a). Subsequently, the analyzing unit 120 returns to the LU factorization process (FIG. 17).

[Step S114] The analyzing unit 120 calls a subroutine called “mvtonporder” and then executes the subroutine.

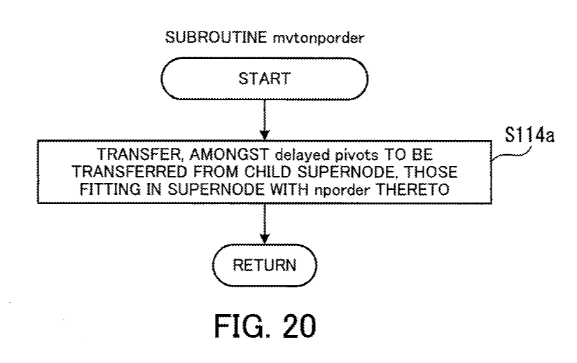

FIG. 20 is a flowchart illustrating processing of subroutine mvtonporder. The analyzing unit 120 transfers, amongst the delayed pivots to be transferred from the child supernode, those fitting in the supernode with nporder to the supernode with nporder (step S114a). Subsequently, the analyzing unit 120 returns to the LU factorization process (FIG. 17).

[Step S115] The analyzing unit 120 calls a subroutine called “cpupdate” and then executes the subroutine. Subroutine cpupdate is a process for updating the column panel of the supernode with nporder, including therein delayed pivots transferred thereto.

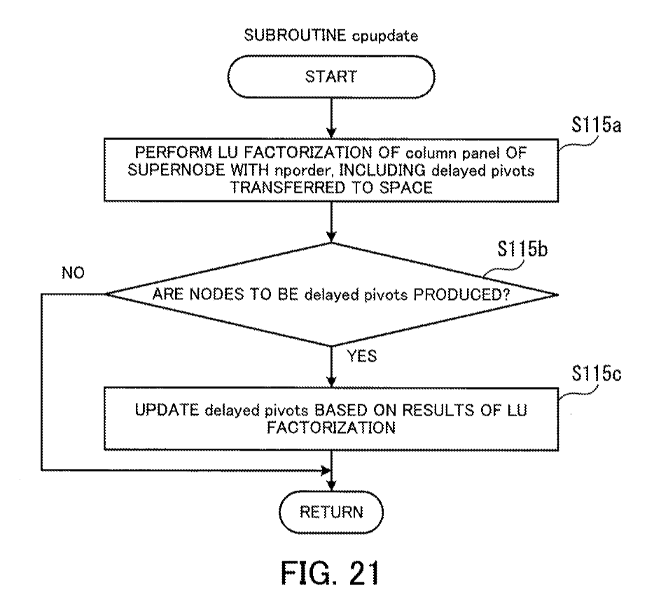

FIG. 21 is a flowchart illustrating processing of subroutine cpupdate. The process of FIG. 21 is described next according to the step numbers in the flowchart.

[Step S115a] The analyzing unit 120 performs LU factorization of the column panel of the supernode with nporder, including therein the delayed pivots transferred to the space.

[Step S115b] The analyzing unit 120 determines whether nodes to be delayed pivots are produced by the LU factorization. If nodes to be delayed pivots are produced, the process moves to step S115c. If no nodes to be delayed pivots are produced, the process of subroutine cpupdate ends.

[Step S115c] Based on the results of the LU factorization, the analyzing unit 120 updates the nodes to be delayed pivots. Subsequently, the analyzing unit 120 returns to the LU factorization process (FIG. 17).

[Step S116] The analyzing unit 120 calls a subroutine called “rpupdate” and then executes the subroutine. Subroutine rpupdate is a process for updating the row panel of the supernode with nporder, including therein delayed pivots transferred thereto.

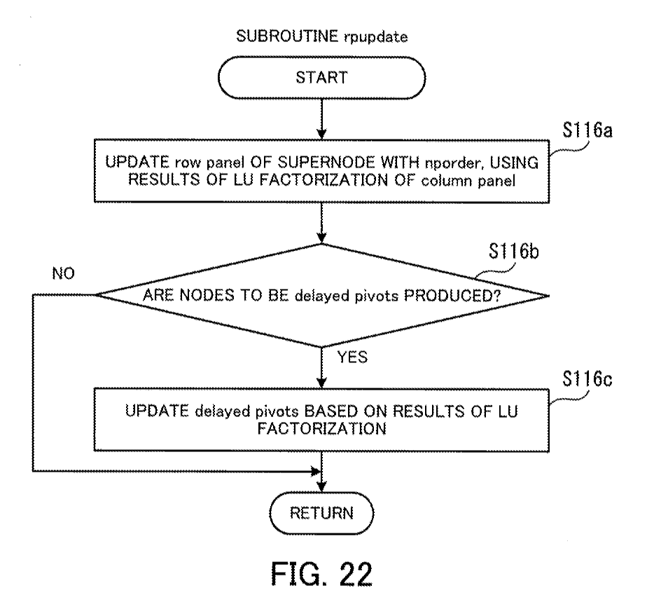

FIG. 22 is a flowchart illustrating processing of subroutine rpupdate. The process of FIG. 22 is described next according to the step numbers in the flowchart.

[Step S116a] The analyzing unit 120 updates the row panel of the supernode with nporder using the results of the LU factorization of the column panel.

[Step S116b] The analyzing unit 120 determines whether nodes to be delayed pivots are produced by the LU factorization. If nodes to be delayed pivots are produced, the process moves to step S116c. If no nodes to be delayed pivots are produced, the process of subroutine rpupdate ends.

[Step S116c] Based on the results of the LU factorization, the analyzing unit 120 updates the nodes to be delayed pivots. Subsequently, the analyzing unit 120 returns to the LU factorization process (FIG. 17).

[Step S117] The analyzing unit 120 determines whether there are delayed pivots that did not fit in the spaces of the supernode with nporder and are therefore left out. If there are left-out delayed pivots, the process moves to step S118. If there is no left-out delayed pivot, the process moves to step S121.

[Step S118] The analyzing unit 120 calls a subroutine called “createmv” and then executes the subroutine. Subroutine createmv is a process for creating a supernode for accommodating the left-out delayed pivots that did not fit in the supernode with nporder as well as the delayed pivots produced by the LU factorization of the supernode with nporder.

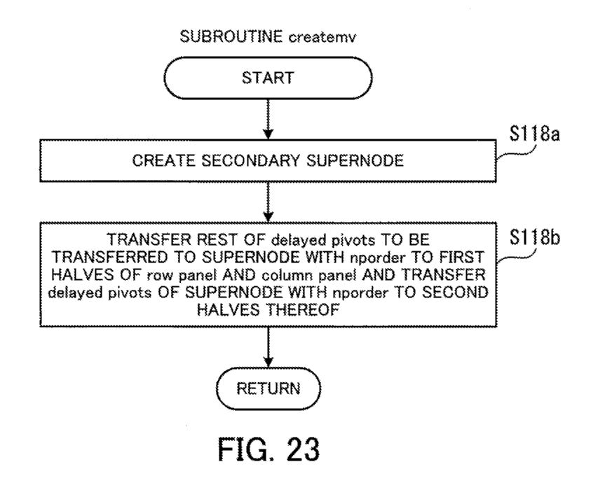

FIG. 23 is a flowchart illustrating processing of subroutine createmv. The process of FIG. 23 is described next according to the step numbers in the flowchart.

[Step S118a] The analyzing unit 120 creates a secondary supernode.

[Step S118b] The analyzing unit 120 transfers the remaining ones of the delayed pivots to be transferred to the supernode with nporder to the first halves of the row and column panels of the secondary supernode. In addition, the analyzing unit 120 transfers delayed pivots included in the supernode with nporder to the second halves of the row and column panels of the secondary supernode. Subsequently, the analyzing unit 120 returns to the LU factorization process (FIG. 17).

[Step S119] The analyzing unit 120 calls a subroutine called “cpupdatenew” and then executes the subroutine. Subroutine cpupdatenew is a process for updating, within the column panel, the left-out delayed pivots (i.e., the first half of the column panel) using the results of the factorization of the supernode with nporder and then performing LU factorization of the entire column panel. Further, if delayed pivots are newly produced, updates are made to nodes corresponding to the delayed pivots.

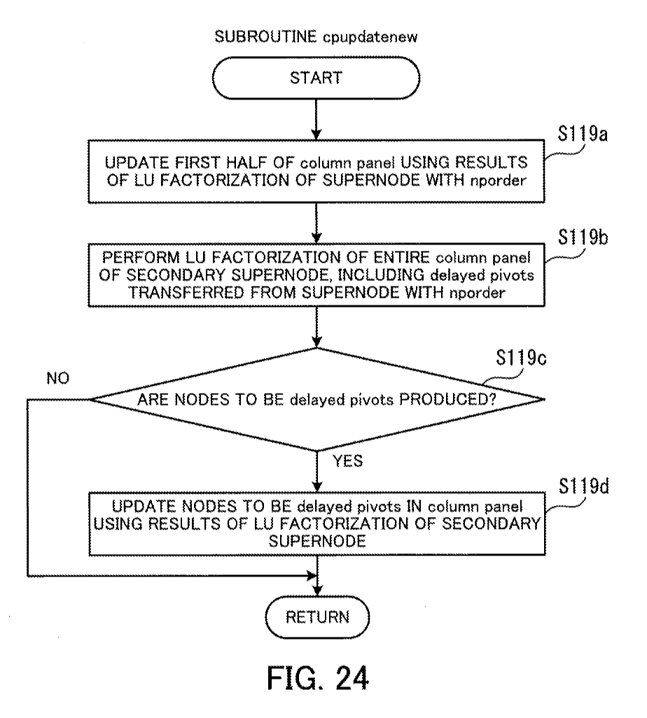

FIG. 24 is a flowchart illustrating processing of subroutine cpupdatenew. The process of FIG. 24 is described next according to the step numbers in the flowchart.

[Step S119a] The analyzing unit 120 updates the first half of the column panel using the results of the LU factorization of the supernode with nporder.

[Step S119b] The analyzing unit 120 performs LU factorization of the entire column panel of the secondary supernode, including therein the delayed pivots transferred from the supernode with nporder (i.e., the second half of the column panel).

[Step S119c] The analyzing unit 120 determines whether nodes to be delayed pivots are produced by the LU factorization. If nodes to be delayed pivots are produced, the process moves to step S119d. If no nodes to be delayed pivots are produced, the process of subroutine cpupdatenew ends.

[Step S119d] Based on the results of the LU factorization of the secondary supernode, the analyzing unit 120 updates the nodes to be delayed pivots in the column panel. Subsequently, the analyzing unit 120 returns to the LU factorization process (FIG. 17).

[Step S120] The analyzing unit 120 calls a subroutine called “rpupdatenew” and then executes the subroutine. Subroutine rpupdatenew is a process for updating the row panel of the secondary supernode using the results of the LU factorization of the supernode with nporder and then updating the row panel again using results of the LU factorization of the column panel of the secondary supernode. Further, if nodes to be delayed pivots are produced, updates are made to the nodes to the delayed pivots.

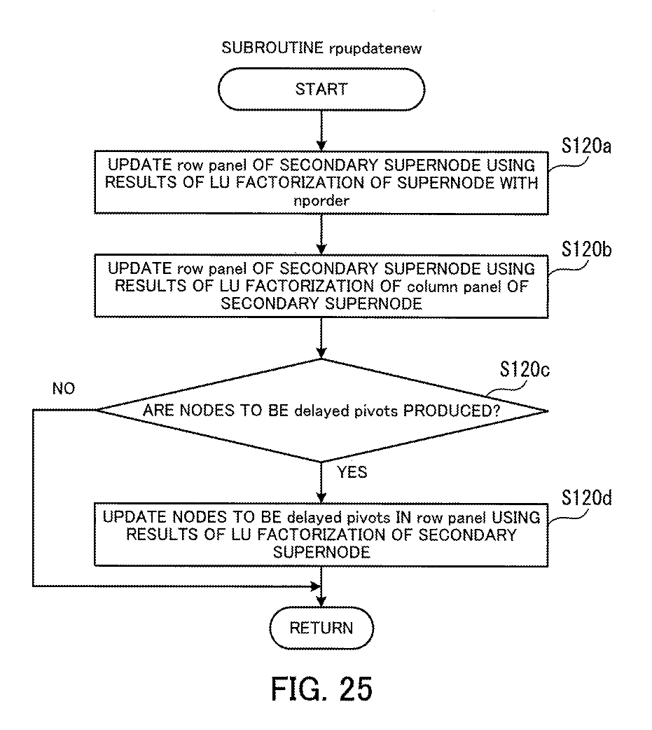

FIG. 25 is a flowchart illustrating processing of subroutine rpupdatenew. The process of FIG. 25 is described next according to the step numbers in the flowchart.

[Step S120a] The analyzing unit 120 updates the row panel of the secondary supernode using the results of the LU factorization of the supernode with nporder.

[Step S120b] The analyzing unit 120 updates the row panel of the secondary supernode using the results of the LU factorization of the column panel of the secondary supernode.

[Step S120c] The analyzing unit 120 determines whether nodes to be delayed pivots are produced by the LU factorization. If nodes to be delayed pivots are produced, the process moves to step S120d. If no nodes to be delayed pivots are produced, the process of subroutine rpupdatenew ends.

[Step S120d] Based on results of the LU factorization of the secondary supernode, the analyzing unit 120 updates the nodes to be delayed pivots in the row panel of the secondary supernode. Subsequently, the analyzing unit 120 returns to the LU factorization process (FIG. 17).

[Step S121] The analyzing unit 120 adds 1 to nporder.

[Step S122] The analyzing unit 120 determines whether the value of the current nporder is larger than the total count of supernodes. If the value of the current nporder exceeds the total count of supernodes, the LU factorization process ends. The value of the current nporder is less than or equal to the total count of supernodes, the process moves to step S112.

By repeating subroutine calls in the above-described procedure, LU factorization of a structurally symmetric matrix is performed efficiently using delayed pivoting.

<LDL^{T} Factorization of Sparse Symmetric Indefinite Matrix>

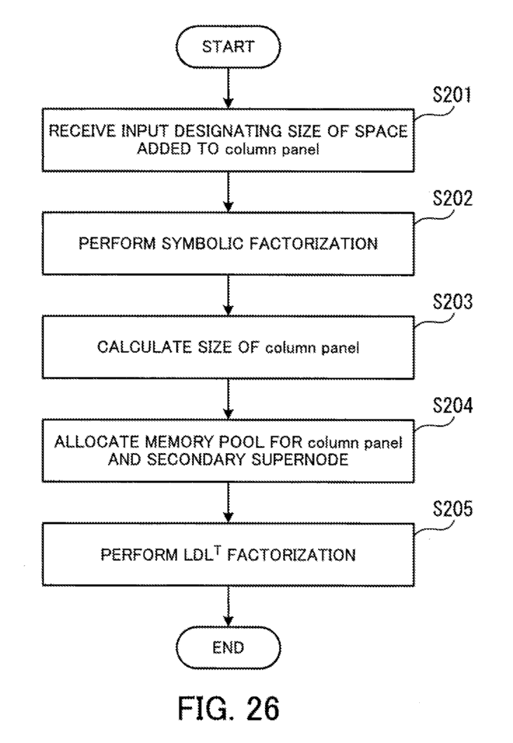

Next described is LDL^{T} Factorization of a sparse symmetric indefinite matrix. As for a symmetric indefinite matrix, only the column panel needs to be considered due to its symmetric structure. FIG. 26 is a flowchart illustrating a procedure of LDL^{T} factorization of a sparse symmetric indefinite matrix. The process of FIG. 26 is described next according to the step numbers in the flowchart.

[Step S201] The analyzing unit 120 receives an input designating the size of a space added to the column panel. For example, the analyzing unit 120 acquires a value indicating the size of the space, input by the user via an input device, e.g., the keyboard 22.

[Step S202] The analyzing unit 120 performs symbolic factorization. The symbolic factorization achieves generation of an elimination tree, detection of supernodes, and generation of supernodal row subtrees.

[Step S203] The analyzing unit 120 calculates the size of the column panel with the added space.

[Step S204] The analyzing unit 120 allocates, in the memory 102, a memory pool used to assign a column-panel area and a secondary supernode area.

[Step S205] The analyzing unit 120 performs LDL^{T} factorization. In the LDL^{T} factorization, the analyzing unit 120 uses the space prepared for transferring delayed pivots. In the case where the count of delayed pivots to be transferred exceed the size of the space, the analyzing unit 120 creates a secondary supernode and stores rows corresponding to the delayed pivots being left out.

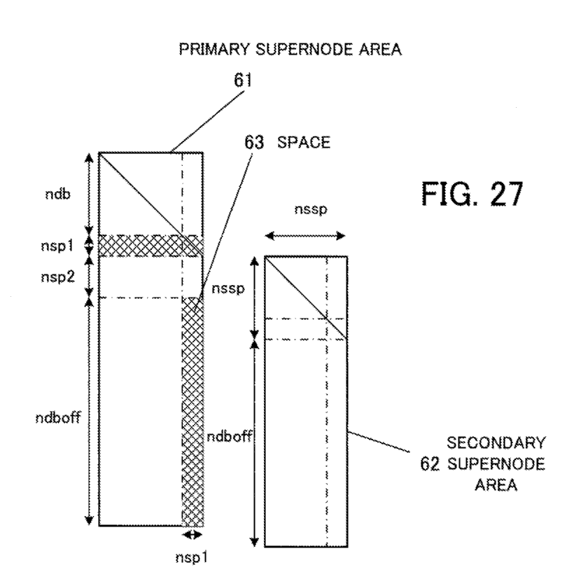

The LDL^{T} factorization is achieved by the above-described procedure. Next, effective use of the memory 102 in the LDL^{T} factorization of a symmetric indefinite matrix is described in detail. FIG. 27 illustrates an example of a panel configuration used in the LDL^{T} factorization of a sparse symmetric indefinite matrix. FIG. 27 depicts panel structures of a primary supernode area 61 and a secondary supernode area 62. The analyzing unit 120 provides a space 63 for the column panel used to store columns collectively. As for the panel of each supernode of a sparse symmetric indefinite matrix, only a part corresponding to the lower triangular matrix L needs to be stored, as illustrated in FIG. 27. As for the transfer of delayed pivots also, a part corresponding to the lower triangular matrix L needs to be transferred.

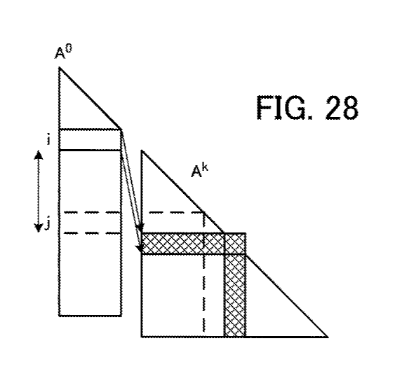

FIG. 28 illustrates an example of transferring a delayed pivot in the LDL^{T} factorization of the symmetric indefinite matrix. The part transferred denoted as hatched area in FIG. 28. That is, the transfer of the delayed pivot is limited, within an original matrix A°, to a submatrix A^{k} with row i and subsequent rows and column i and subsequent columns. Thus, only the column panel needs to be considered in the case of a sparse symmetric indefinite matrix.

<Specific Procedure for LDL^{T} Factorization>

Also in a symmetric indefinite matrix, nonzero elements are arranged symmetrically along the main diagonal and, therefore, dependencies in the factorization of individual nodes are represented by an elimination tree. The analyzing unit 120 forms each supernode by grouping nodes in parent-child relationships in the elimination tree, with nearly identical nonzero patterns. For such supernodes, it is possible to construct an elimination tree representing dependencies among the supernodes, which is referred to as a supernodal elimination tree. As in the case of an elimination tree, the analyzing unit 120 assigns postorder numbers to the individual supernodes in the supernodal elimination tree. Let us consider now the factored lower triangular matrix L. Supernodes that are sets of columns and correspond to parts where nonzero elements are present form a supernodal row subtree, which is an equivalent of a row subtree.

The analyzing unit 120 performs factorization of each node in the following order: [1] the analyzing unit 120 takes out each supernode in the postorder sequence and repeats the following steps [2] and [3]; [2] the analyzing unit 120 updates the values of elements in the selected supernode according to contributions from the supernodal row subtree; and [3] after the updates, the analyzing unit 120 performs LDL^{T} factorization of the column panel of the supernode.

In the case of a symmetric indefinite matrix, the analyzing unit 120 calculates updates of a factorization-target supernode in the following procedure.

[1] The analyzing unit 120 takes out each constituent supernode from the supernodal row subtree of the target supernode and repeats the following steps [1.1] and [1.2] until all the constituent supernodes are taken out. In this regard, the analyzing unit 120 treats a secondary supernode of each constituent supernode of the supernodal row subtree as a constituent of the supernodal row subtree.

[1.1] The analyzing unit 120 updates the column panel. Details of this step are presented in the column panel update procedure (a.1 to a.4) to be described below.

[1.2] The analyzing unit 120 updates the row panel, as with [1.1].

[2] The analyzing unit 120 transfers delayed pivots and performs LDL^{T} factorization.

[2.1] The analyzing unit 120 calculates the total count of delayed pivots transferred from a child of the target supernode, “numdp”. Then, the analyzing unit 120 takes delayed pivots to fit in the space out of numdp and puts them in the space.

[2.2] The analyzing unit 120 performs LDL^{T} factorization.

[2.3] If delayed pivots are produced by the LDL^{T} factorization of the target supernode, the analyzing unit 120 updates these delayed pivots using results of the LDL^{T} factorization.

[2.4.1] The analyzing unit 120 allocates a secondary supernode sufficient to accommodate restdp of numdp, which did not fit in the space, if any, and the delayed pivots produced in [2.3]. The analyzing unit 120 then transfers the appropriate delayed pivots to the secondary supernode. Subsequently, the analyzing unit 120 updates restdp using the results of the LDL^{T} factorization of the target supernode.

[2.4.2] The analyzing unit 120 performs LDL^{T} factorization of the secondary supernode. If delayed pivots are produced by the factorization, the analyzing unit 120 updates these delayed pivots using results of the factorization.

The procedure for calculating updates of each supernode has been described thus far. Next, the column panel update procedure (a.1 to a.4) is described in detail. The calculation for updating the column panel is performed in the following procedure.

[a.1] The analyzing unit 120 takes out each constituent supernode from the supernodal row subtree and repeats the following steps until all the constituent supernodes are taken out.

[a.2] Due to symmetric property, the transpose of the column panel(nc1, nc2) corresponds to a factored matrix L^{T}, and is the row panel. The transpose of a set of rows is stored in the column panel. The analyzing unit 120 copies, amongst columns stored in the transposed column panel, columns with column numbers of the supernode to be updated to the working matrix B(nc2, len). len represents the count of columns copied. Within the column panel, the analyzing unit 120 finds the top (“ntop”) of nodes to be updated, identified by their node numbers. The column panel is a two-dimensional array, cpanel(nc1, nc2).

[a.3] The analyzing unit 120 calculates a matrix C(nc1−ntop+1, len)←cpanel(ntop-nc1, nc2)×D×B(nc2, len).

[a.4] The analyzing unit 120 updates each column of the matrix C by subtracting each element of the column from an element of the supernode, having the same row and column numbers as those of the element of the column to be updated.

At this point, delayed pivots are transferred and, then, LDL^{T} factorization with 1-by-1 or 2-by-2 diagonal blocks is performed. If the space runs out by the transfer of the delayed pivots from its child supernode, the analyzing unit 120 creates a secondary supernode. The 1-by-1 or 2-by-2 diagonal blocks are denoted by D. The analyzing unit 120 stores the diagonal blocks in the diagonal and subdiagonal of the column panel.

In the factorization of a symmetric indefinite matrix, the analyzing unit 120 uses diagonal pivoting enabling each 1-by-1 or 2-by-2 submatrix. The matrix A is factored as follows, using the matrix P as a 1-by-1 or 2-by-2 sub-matrix. This is performed recursively.

$$A = ( \begin{matrix}P & {C}^{T} \\ C & B\end{matrix} ) = ( \begin{matrix}I & 0 \\ {CP}^{- 1} & I\end{matrix} ) ( \begin{matrix}P & 0 \\ 0 & B - {CP}^{- 1} {C}^{T}\end{matrix} ) ( \begin{matrix}I & {P}^{- 1} {C}^{T} \\ 0 & I\end{matrix} ) \qquad ( 1 )$$

By applying this strategy to the column panel, LDL^{T} factorization of the column panel is performed. The matrix D is a 1-by-1 or 2-by-2 symmetric block diagonal matrix. When the diagonal element is 1 and D is a 2-by-2 block, the subdiagonal elements are 0.

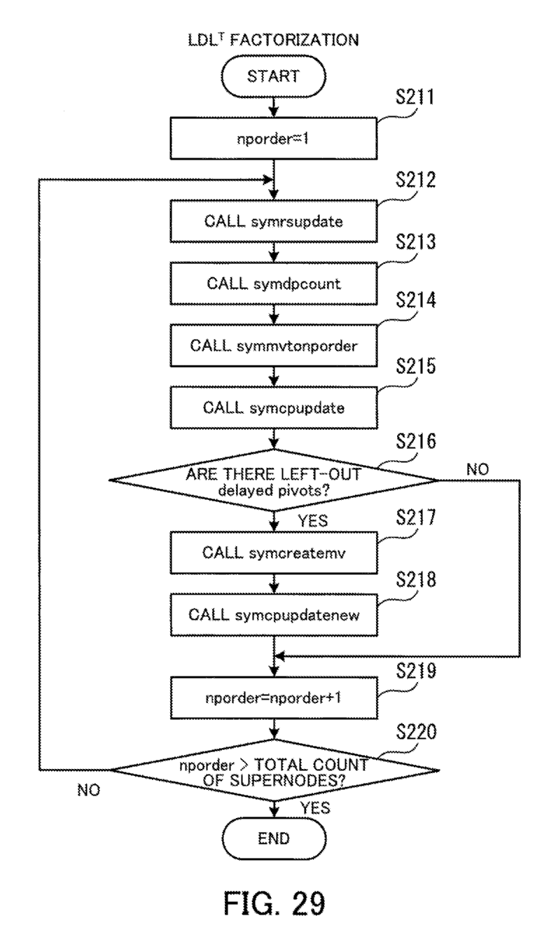

FIG. 29 is a flowchart illustrating a procedure of LDL^{T} factorization. The process of FIG. 29 is described next according to the step numbers in the flowchart.

[Step S211] The analyzing unit 120 sets nporder to 1.

[Step S212] The analyzing unit 120 calls a subroutine called “symrsupdate” and then executes the subroutine.

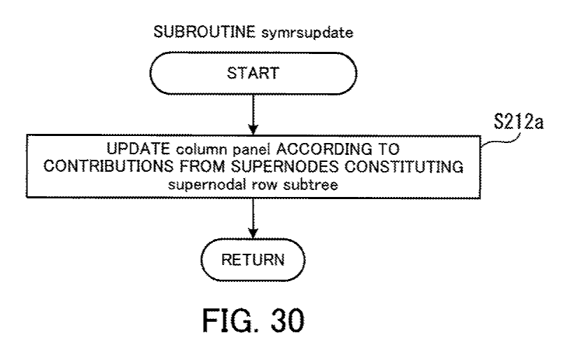

FIG. 30 is a flowchart illustrating processing of subroutine symrsupdate. The analyzing unit 120 updates the column panel according to contributions from supernodes constituting the supernodal row subtree of the supernode with nporder, except for the supernode with nporder. The analyzing unit 120 updates the column panel including nodes newly created, if any (step S212a). Subsequently, the analyzing unit 120 returns to the LDL^{T} factorization process (FIG. 29).

[Step S213] The analyzing unit 120 calls a subroutine called “symdpcount” and then executes the subroutine.

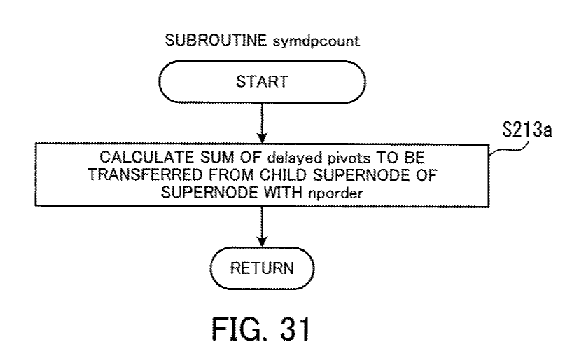

FIG. 31 is a flowchart illustrating processing of subroutine symdpcount. The analyzing unit 120 calculates the sum of delayed pivots to be transferred to the supernode with nporder from its child supernode (step S213a). Subsequently, the analyzing unit 120 returns to the LDL^{T} factorization process (FIG. 29).

[Step S214] The analyzing unit 120 calls a subroutine called “symmvtonporder” and then executes the subroutine.

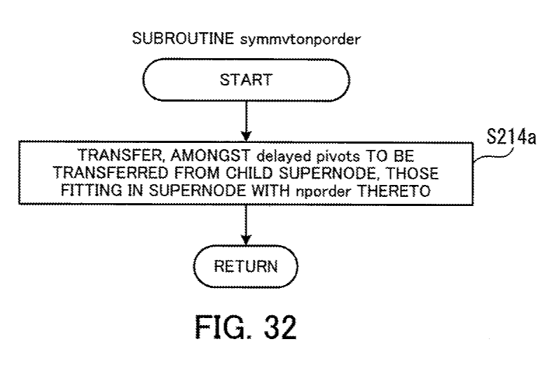

FIG. 32 is a flowchart illustrating processing of subroutine symmvtonporder. The analyzing unit 120 transfers, amongst the delayed pivots to be transferred from the child supernode, those fitting in the supernode with nporder to the supernode with nporder (step S214a). Subsequently, the analyzing unit 120 returns to the LDL^{T} factorization process (FIG. 29).

[Step S215] The analyzing unit 120 calls a subroutine called “symcpupdate” and then executes the subroutine. Subroutine cpupdate is a process for updating the column panel of the supernode with nporder, including therein delayed pivots transferred thereto.

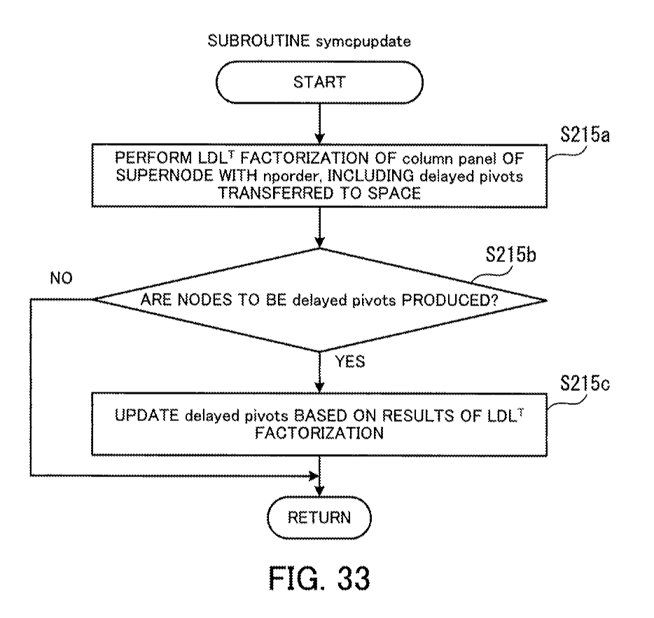

FIG. 33 is a flowchart illustrating processing of subroutine symcpupdate. The process of FIG. 33 is described next according to the step numbers in the flowchart.

[Step S215a] The analyzing unit 120 performs LDL^{T} factorization of the column panel of the supernode with nporder, including therein the delayed pivots transferred to the space.

[Step S215b] The analyzing unit 120 determines whether nodes to be delayed pivots are produced by the LDL^{T} factorization. If nodes to be delayed pivots are produced, the process moves to step S215c. If no nodes to be delayed pivots are produced, the process of subroutine symcpupdate ends.

[Step S215c] Based on the results of the LDL^{T} factorization, the analyzing unit 120 updates the nodes to be delayed pivots. Subsequently, the analyzing unit 120 returns to the LDL^{T} factorization process (FIG. 29).

[Step S216] The analyzing unit 120 determines whether there are delayed pivots that did not fit in the space of the supernode with nporder and are therefore left out. If there are left-out delayed pivots, the process moves to step S217. If there is no left-out delayed pivot, the process moves to step S219.

[Step S217] The analyzing unit 120 calls a subroutine called “symcreatemv” and then executes the subroutine. Subroutine symcreatemv is a process for creating a supernode for accommodating the left-out delayed pivots that did not fit in the supernode with nporder as well as the delayed pivots produced by the LDL^{T} factorization of the supernode with nporder.

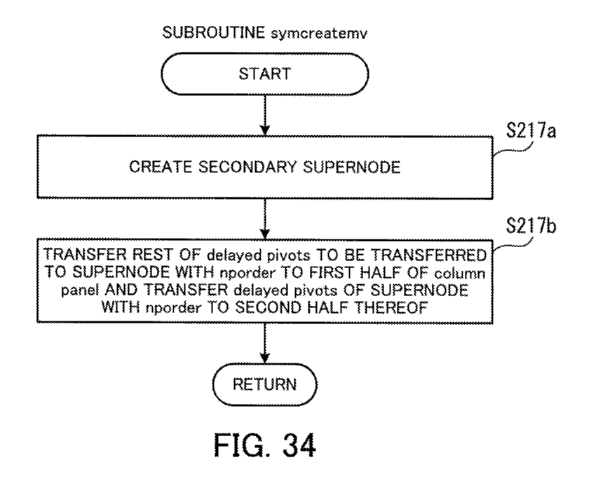

FIG. 34 is a flowchart illustrating processing of subroutine symcreatemv. The process of FIG. 34 is described next according to the step numbers in the flowchart.

[Step S217a] The analyzing unit 120 creates a secondary supernode.

[Step S217b] The analyzing unit 120 transfers the remaining ones of the delayed pivots to be transferred to the supernode with nporder to the first half of the column panel of the secondary supernode. In addition, the analyzing unit 120 transfers delayed pivots included in the supernode with nporder to the second half of the column panel of the secondary supernode. Subsequently, the analyzing unit 120 returns to the LDL^{T} factorization process (FIG. 29).

[Step S218] The analyzing unit 120 calls a subroutine called “symcpupdatenew” and then executes the subroutine. Subroutine symcpupdatenew is a process for updating, within the column panel, the left-out delayed pivots (i.e., the first half of the column panel) using the results of the factorization of the supernode with nporder and then performing LDL^{T} factorization of the entire column panel. Further, if delayed pivots are newly produced, updates are made to nodes corresponding to the delayed pivots.

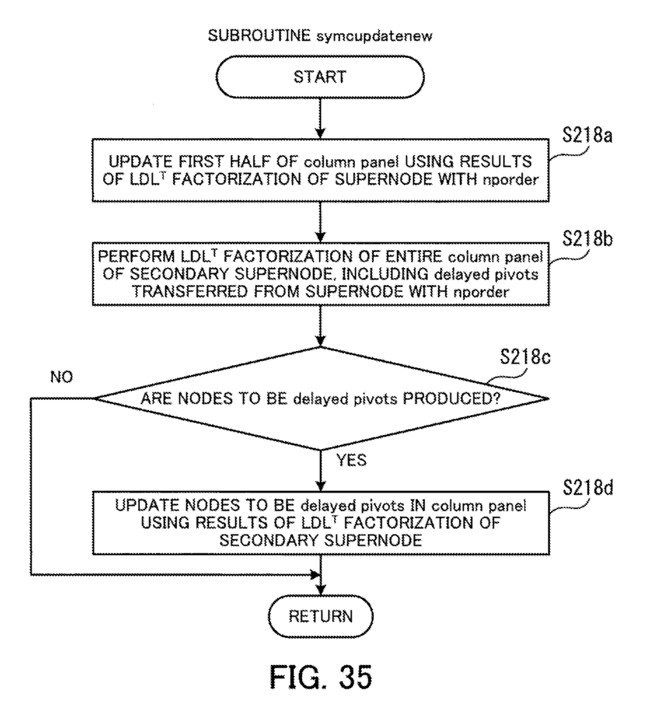

FIG. 35 is a flowchart illustrating processing of subroutine symcpupdatenew. The process of FIG. 35 is described next according to the step numbers in the flowchart.

[Step S218a] The analyzing unit 120 updates the first half of the column panel using the results of the LDL^{T} factorization of the supernode with nporder.

[Step S218b] The analyzing unit 120 performs LDL^{T} factorization of the entire column panel of the secondary supernode, including therein the delayed pivots transferred from the supernode with nporder (i.e., the second half of the column panel).

[Step S218c] The analyzing unit 120 determines whether nodes to be delayed pivots are produced by the LDL^{T} factorization. If nodes to be delayed pivots are produced, the process moves to step S218d. If no nodes to be delayed pivots are produced, the process of subroutine symcpupdatenew ends.

[Step S218d] Based on the results of the LDL^{T} factorization of the secondary supernode, the analyzing unit 120 updates the nodes to be delayed pivots in the column panel. Subsequently, the analyzing unit 120 returns to the LDL^{T} factorization process (FIG. 29).

[Step S219] The analyzing unit 120 adds 1 to nporder.

[Step S220] The analyzing unit 120 determines whether the value of the current nporder is larger than the total count of supernodes. If the value of the current nporder exceeds the total count of supernodes, the LDL^{T} factorization process ends. The value of the current nporder is less than or equal to the total count of supernodes, the process moves to step S212.

By repeating subroutine calls in the above-described procedure, LDL^{T} factorization of a structurally symmetric matrix is performed efficiently using delayed pivoting.

According to one aspect, it is possible to improve the efficiency of memory management in matrix factorization.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A calculator comprising:
a memory configured to store, as results of factorization of a matrix, a plurality of matrices including a lower triangular matrix and an upper triangular matrix, the matrix having nonzero elements arranged symmetrically along a diagonal; and
a processor configured to perform a procedure including:
dividing, based on an arrangement of the nonzero elements, the matrix into a plurality of process units for factorization processing, each of which is a set of rows and columns sharing successive diagonal elements, and allocating, in the memory, a first storage area with a storage capacity with respect to each of the plurality of process units, the storage capacity of the first storage area corresponding to a total data volume obtained by adding a data volume of the set of rows and columns of said each process unit to a data volume of a predetermined count of rows and columns,
selecting each of the plurality of process units as a target process unit in a predetermined order, and performing, with use of the first storage area, a first factorization process on the set of rows and columns of the target process unit and rows and columns transferred to the target process unit, the rows and columns being transferred from process units having already undergone the factorization processing because values of diagonal elements shared by the rows and columns are individually less than or equal to a predetermined value,
allocating, in the memory, a second storage area with a storage capacity when there are, among rows and columns determined to be transferred as a result of the first factorization process because values of diagonal elements shared by the rows and columns are individually less than Or equal to a predetermined value, rows and columns that do not fit in and are therefore left out of the first storage area, the storage capacity of the second storage area corresponding to a data volume of the rows and columns left out of the first storage area, and
performing a second factorization process on the rows and columns left out of the first storage area with use of the second storage area.

2. The calculator according to claim 1, wherein:
the performing the first factorization process and the performing the second factorization process include transferring, when i^{th} row and column (i is an integer greater than or equal to 1) are transfer targets, elements of the i^{th} column having row numbers equal to or greater than i to a position following the columns of the target process unit and transferring elements of the i^{th} row having column numbers greater than i to a position following the rows of the target process unit.

3. The calculator according to claim 1, wherein:
the procedure further includes determining parent-child relationships among the plurality of process units according to a predetermined rule, and
the performing the first factorization process includes transferring, to positions following the rows and columns of the target process unit, rows and columns having been unable to pass through the factorization processing of a process unit corresponding to a child of the target process unit amongst process units having already undergone the factorization processing, and then performing the first factorization process, the rows and columns having been unable to pass through the factorization processing because values of diagonal elements shared by the rows and columns are individually less than or equal to a predetermined value.

4. A matrix factorization method comprising:
dividing, by a processor connected to a memory, based on an arrangement of nonzero elements of a matrix, the matrix into a plurality of process units for factorization processing, each of which is a set of rows and columns sharing successive diagonal elements, and allocating, in the memory, a first storage area with a storage capacity with respect to each of the plurality of process units, the storage capacity of the first storage area corresponding to a total data volume obtained by adding a data volume of the set of rows and columns of said each process unit to a data volume of a predetermined count of rows and columns, the matrix having the nonzero elements arranged symmetrically along a diagonal, the memory being configured to store a plurality of matrices including a lower triangular matrix and an upper triangular matrix as results of factoriztation of the matrix;
selecting, by the processor, each of the plurality of process units as a target process unit in a predetermined order, and performing, with use of the first storage area, a first factorization process on the set of rows and columns of the target process unit and rows and columns transferred to the target process unit, the rows and columns being transferred from process units having already undergone the factorization processing because values of diagonal elements shared by the rows and columns are individually less than or equal to a predetermined value;
allocating, by the processor, in the memory, a second storage area with a storage capacity when there are, among rows and columns determined to be transferred as a result of the first factorization process because values of diagonal elements shared by the rows and columns are individually less than or equal to a predetermined value, rows and columns that do not fit in and are therefore left out of the first storage area, the storage capacity of the second storage area corresponding to a data volume of the rows and columns left out of the first storage area; and
performing, by the processor, a second factorization process on the rows and columns left out of the first storage area with use of the second storage area.

5. A non-transitory computer-readable storage medium storing a computer program that causes a computer including a memory to perform a procedure comprising:
dividing based on an arrangement of nonzero elements of a matrix, the matrix into a plurality of process units for factorization processing, each of which is a set of rows and columns sharing successive diagonal elements, and allocating, in the memory, a first storage area with a storage capacity with respect to each of the plurality of process units, the storage capacity of the first storage area corresponding to a total data volume obtained by adding a data volume of the set of rows and columns of said each process unit to a data volume of a predetermined count of rows and columns, the matrix having the nonzero elements arranged symmetrically along a diagonal, the memory being configured to store a plurality of matrices including a lower triangular matrix and an upper triangular matrix as results of factorization of the matrix;
selecting each of the plurality of process units as a target process unit in a predetermined order, and performing, with use of the first storage area, a first factorization process on the set of rows and columns of the target process unit and rows and columns transferred to the target process unit, the rows and columns being transferred from process units having already undergone the factorization processing because values of diagonal elements shared by the rows and columns are individually less than or equal to a predetermined value;
allocating in the memory, a second storage area with a storage capacity when there are, among rows and columns determined to be transferred as a result of the first factorization process because values of diagonal elements shared by the rows and columns are individually less than or equal to a predetermined value, rows and columns that do not fit in and are therefore left out of the first storage area, the storage capacity of the second storage area corresponding to a data volume of the rows and columns left out of the first storage area; and
performing a second factorization process on the rows and columns left out of the first storage area with use of the second storage area.
